(19) United States
(12) Patent Application Publication
(10) Pub. No.: US 2026/0303357 A1
(43) Pub. Date: Oct. 1, 2026

(54) SIGNATURE SYSTEM AND METHOD

(71) Applicant: NEC Corporation, Tokyo (JP)

(72) Inventors: Haruna FUKUDA, Tokyo (JP); Toshiyuki ISSHIKI, Tokyo (JP); Hiroto TAMIYA, Tokyo (JP); Yukimasa SUGIZAKI, Tokyo (JP); Saki MORIOKA, Tokyo (JP)

(73) Assignee: NEC Corporation, Tokyo (JP)

(21) Appl. No.: 19/577,534

(22) Filed: Mar. 25, 2026

(30) Foreign Application Priority Data
Mar. 28, 2025 (JP) 2025-057088

(51) Int. Cl. H04L 9/32; H04L 9/08; H04L 9/14

(52) U.S. Cl. CPC H04L 9/3247; H04L 9/0825; H04L 9/0866; H04L 9/14

(57) ABSTRACT

A system includes a plurality of distributed signature generation apparatuses, each configured to generate a distributed signature, wherein at least one distributed signature generation apparatus of the plurality of distributed signature generation apparatuses is configured to receive a first parameter generated using a distributed signing key corresponding to the at least one first apparatus and first biometric information and generate the distributed signature using second biometric information and the first parameter.

### FIELD

The present invention is based upon and claims the benefit of the priority of Japanese patent application No. 2025-057088 filed on Mar. 28, 2025, the disclosure of which is incorporated herein in its entirety by reference thereto.

The present invention relates to a signature system, a signature method and a non-transitory medium.

### BACKGROUND

A digital signature is a technology that enables verification of a document's creator and whether a document has not been altered after generation of a signature for the document, by verifying the signature that was generated using a signing key that is assumed to be held only by a signer.

Following describes an example of a typical digital signature algorithm.
Key generation: (sk, pk)←KeyGen (1^{κ}): generates a pair consisting of a signing key sk and a verification key pk based on a security parameter κ (key length).
Signature generation: σ←Sign(sk, m): generates a signature σ for a document (message) M using the signing key sk.
Signature Verification: 1/0←Verify (pk, M, σ): verifies validity of a pair consisting of the document m and the signature σ using the verification key pk. This process simultaneously verifies two points: whether the signature was generated using the signing key corresponding to the verification key pk, and whether the signature was generated for that specific document M. The verification function Verify may return 1 if the verification result is “accepted” and 0 if “rejected” When the verification key pk is publicly available, anyone who obtains the document and the signature can perform verification.

Use cases for digital signatures include, for example,
Email Protection (S/MIME (Secure/Multipurpose Internet Mail Extensions));
Electronic contracts (where a party's digital signature may be affixed to electronic data of a contract document instead of affixing a seal to a written contract); and
Cryptocurrency transactions (for example, a message containing information such as “send this amount to this address” and a sender's digital signature for that message may be recorded on a blockchain. The transaction may be completed when this signature is successfully verified).

In a cryptocurrency, incidents of cryptocurrency theft or crypto hack have occurred, which are ascribable to key management issues at exchanges. For exchanges managing large amounts of cryptocurrency, countermeasures against unauthorized key usage are particularly critical.

In distributed signature schemes such as a multi-signature, a transaction involving cryptocurrency may be completed by generating a signature using multiple signing keys (distributed secret keys) held by multiple administrators, respectively. Sending a fund(s) using a multi-signature can be performed when such a condition is met as collecting a predetermined number of distributed secret keys (e.g., two out of three distributed secret keys). In a distributed signature scheme, distributed secret keys may be managed by multiple administrators. During a signing process, a signature cannot be generated unless a required number of administrators participate in a signature generation process. Furthermore, as compared to digital signatures, it becomes more difficult for an external attacker(s) to steal a secret key or for an internal attacker(s) to perform unauthorized use thereof. This is because, for example, to forge a signature, multiple distributed secret keys are needed.

By using biometric information as a key, a biometrics-based signature scheme may reduce such a risk as losing a signing key. PTL (Patent Literature) 1 discloses a system capable of generating a signature for arbitrary message (electronic document) using biometric information as a secret key without requiring any data (such as auxiliary information) other than the biometric information.
[PTL 1] Japanese Patent No. P5707311B

### SUMMARY

The following describes a n analysis by the inventors of the present application.

In distributed signature systems, association between distributed secret keys (distributed signing keys) and their administrators is weak. For example, it is necessary to prevent anyone other than a designated administrator(s) from accessing distributed secret keys. However, due to careless operations or powerful attacks, situations may arise where it is impossible to prevent a non-administrator(s) from accessing distributed secret key. If anyone other than the administrator gains access to the distributed secret key, a signature may be generated even when the administrator is not present, which necessitates security measures.

Accordingly, one of objects of the present disclosure is to provide a signature system, method, and non-transitory medium, each enabling further improvement of security of distributed signature schemes.

According to one aspect of the present disclosure, a signature system includes a plurality of first apparatuses, each generating a distributed signature, wherein at least one first apparatus of the plurality of first apparatuses includes at least a processor configured to receive a first parameter generated using a distributed signing key corresponding to the at least one first apparatus and first biometric information, and generate a distributed signature using second biometric information and the first parameter.

According to one aspect of the present disclosure, there is provided a signature method in which each of a plurality of distributed signature generation parts generates a distributed signature, the method comprising, by at least one distributed signature generation part of the plurality of distributed signature generation parts:
receiving a first parameter generated using a distributed signing key corresponding to the at least one distributed signature generation part and first biometric information; and
generating the distributed signature using second biometric information and the first parameter.

According to one aspect of the present disclosure, there is provided a non-transitory computer readable medium storing a program to cause a processor of at least one distributed signature generation apparatus of a signature generation plurality of distributed apparatuses, each generating a distributed signature, to execute processing comprising: receiving a first parameter generated using a distributed signing key corresponding to the at least one distributed signature generation apparatus and first biometric information; and generating the distributed signature using second biometric information and the first parameter.

The present disclosure enables further improvement in security of a distributed signature scheme.

### BRIEF DESCRIPTION OF DRAWINGS

FIG. 1 is a diagram illustrating at least one example of several embodiments of the present disclosure.

FIG. 2 is a diagram illustrating at least one example of several embodiments of the present disclosure.

FIG. 3 is a diagram illustrating at least one example of several embodiments of the present disclosure.

FIG. 4 is a diagram illustrating at least one example of several embodiments of the present disclosure.

FIG. 5 is a diagram illustrating at least one example of several embodiments of the present disclosure.

FIG. 6 is a diagram illustrating at least one example of several embodiments of the present disclosure.

FIG. 7 is a diagram illustrating at least one example of several embodiments of the present disclosure.

FIG. 8 is a diagram illustrating at least one example of several embodiments of the present disclosure.

FIGS. 9A and 9B illustrate at least one example of several embodiments of the present disclosure.

### EXAMPLE EMBODIMENTS

The following describes example embodiments of the present disclosure. According to the present disclosure, in one example configuration of embodiments, at least one first apparatus of a plurality of first apparatuses, each generating a distributed signature, is configured to receive a first parameter generated using a distributed signing key and first biometric information and generate a distributed signature using second biometric information and the first parameter. The plurality of first apparatuses may be configured to generate distributed signatures according to a signature scheme selected from, for example, an aggregate signature, sequential aggregate signature, multi-signature, and threshold signature. In the present disclosure, as will be described in embodiments, when a single signature is generated by synthesizing (combining) or aggregating multiple signatures, each of these multiple signatures may be referred to as a distributed signature. A signing key used to generate such a distributed signature may be referred to as a distributed signing key.

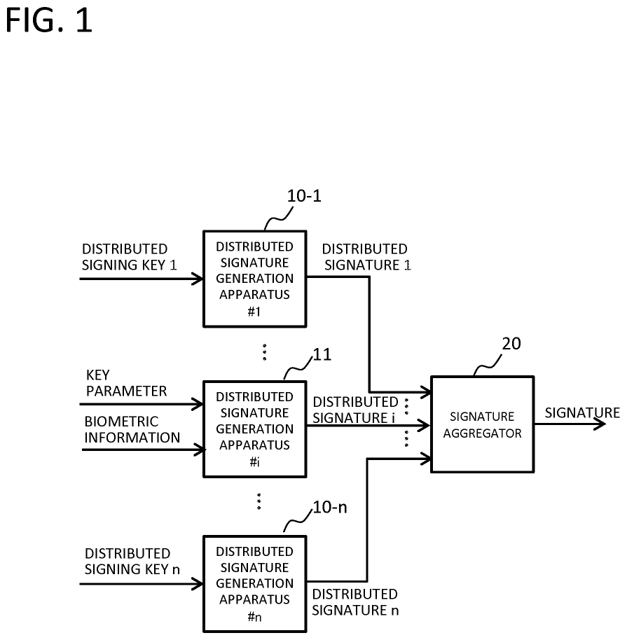

FIG. 1 is a schematic diagram illustrating an example of one of embodiments of the present disclosure. Referring to FIG. 1, among the n distributed signature generation apparatuses #1 to #n that each generates one of n distributed signatures, at least one distributed signature generation apparatus 11 (e.g., the i-th distributed signature generation apparatus) may be configured to generate the i-th distributed signature using biometric information. In this case, the remaining distributed signature generation apparatuses 10-1 to 10-n generate distributed signatures using their respective corresponding distributed signing keys as is.

In FIG. 1, a distributed signature generation apparatus that generates distributed signatures using distributed signing keys is designated by a reference number 10. For drawing convenience, branch numbers of the reference number 10 correspond to the numbers of the distributed signature generation apparatuses (an n-th distributed signature generation apparatus is designated by a reference number 10-n). In a case where an i-th distributed signature generation apparatus 11 is the 1st or n-th distributed signature generation apparatus, the distributed signature generation apparatus 11 may be arranged at the topmost or bottommost position. In this case, the distributed signature generation apparatus 10-1 in FIG. 1 becomes 10-2, or the distributed signature generation apparatus 10-n becomes 10-(n−1).

A signature aggregator (SA) 20 is configured to aggregate the first through n-th distributed signatures from the distributed signature generation apparatuses #1 to #n into a single signature to output the single signature.

In FIG. 1, the i-th (i∈{1, . . . , n}) distributed signature generation apparatus 11, may be configured to receive a key parameter (first key parameter) generated using an i-th distributed signing key and biometric information of an i-th signer corresponding to an i-th distributed signing key, acquire the biometric information of, for example, the same modality as the biometric information, and generate an i-th distributed signature i using the acquired first key parameter.

By using a key parameter generated with the biometric information of the i-th signer to generate the i-th (I∈{1, . . . , n}) distributed signature, the i-th distributed signature cannot be correctly generated if the i-th signer is absent. If the i-th distributed signature is fraudulently generated by someone other than the i-th signer, that is, generated without using the i-th signer's biometric information, signature obtained by aggregating the n distributed signatures is going to be rejected on a verification stage.

In a case of a multi-signature described later, multiple signatures (σi) (i=1, . . . , n) from multiple signers are aggregated to generate a single signature (o). In this case, the “distributed signature generation apparatus” in FIG. 1 may be read as either “signature generation apparatus” or “signer”, and “distributed signature” may be read simply as “signature”. Furthermore, “distributed signing key” may be read as “signing key” in correspondence with a verification key.

It is noted that in FIG. 1, an arrow indicating a single direction of data (signal) does not necessarily imply a unidirectional signal flow between apparatuses. A control signal(s) may be sent and received between the apparatuses according to a communication protocol adopted. The same applies to the other figures.

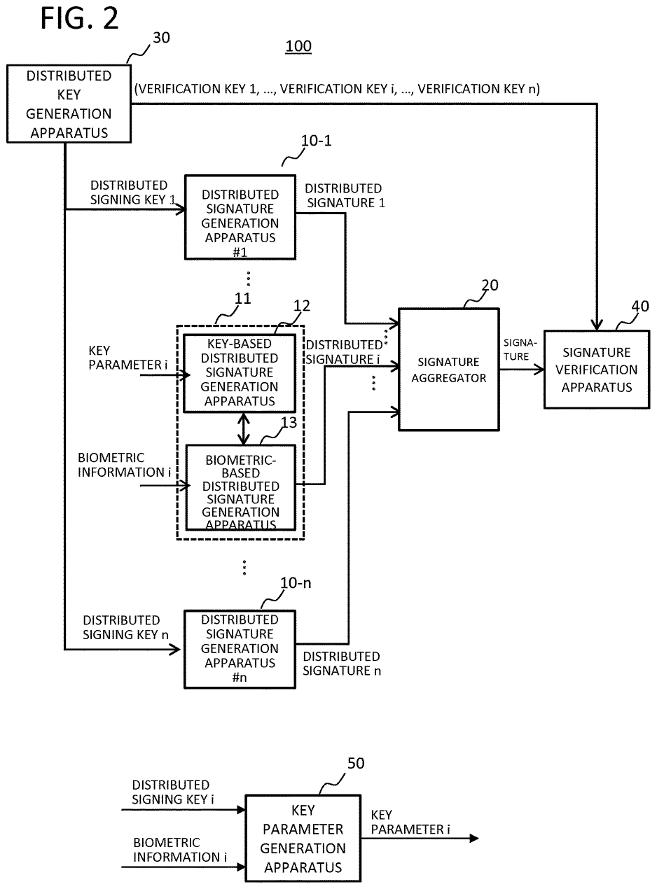

FIG. 2 illustrates an example of a signature system 100 including the configuration illustrated in FIG. 1. A distributed key generation apparatus 30 generates n pairs of (distributed signing key 1 (x1) and verification key 1 (pk1)), . . . , and (distributed signing key n(xn) and verification key n(pkn)) and transmits the distributed signing keys other than the i-th distributed signing key i(xi) (i∈{1, . . . , n}) to the distributed signature generation apparatus 10-j (j i∈{1, . . . , n}), respectively. The distributed key generation apparatus 30 may transmit n verification keys (verification key 1 (pk1), . . . , verification key n (pkn)) to the signature verification apparatus 40. Alternatively, depending on the signature scheme used, the n verification keys (verification key 1 (pk1), . . . , the n verification keys (pkn)) may be transmitted to each of the n distributed signature generation apparatuses #1 to #n.

The key parameter generation apparatus 50 acquires the i-th distributed signing key corresponding to the i-th distributed signature generation apparatus 11 and the biometric information of the i-th signer, and synthesizes these to generate a key parameter i and transmits the parameter to the i-th distributed signature generation apparatus 11. In FIG. 2, the i-th distributed signing key is denoted as the distributed signing key i, and the biometric information of the i-th signer is denoted as the biometric information i.

The distributed key generation apparatus 30 may be configured as such where multiple signers generate a pair of a distributed signing key (signing key) and a verification key at their respective terminals, as will be described in examples below. The distributed key generation apparatus 30 may also include such a configuration that the multiple signers generate distributed signatures (signatures) at their respective terminals.

The signature aggregator 20 receives the first to n-th distributed signatures (σ1 to σn) generated by the first to n-th distributed signature generation apparatuses #1 to #n (10-1, . . . , 11, . . . , 10-n). The signature aggregator aggregates the first to n-th distributed signatures (σ1 to σn) to generate a single signature (aggregate signature) σ and transmits the single signature (aggregate signature) σ to the signature verification apparatus 40.

The signature verification apparatus 40 performs signature verification: Verify((pk1, . . . , pkn), m, σ) using the aggregate signature (σ), the message to be signed (m), and the verification keys (pk1, . . . , pkn). There are no particular restrictions on timing of the signature verification by the signature verification apparatus 40 (i.e., the signature verification may be performed at any time). The signature verification apparatus 40 may perform signature verification multiple times. Additionally, multiple verifiers may perform signature verification using their respective signature verification apparatuses 40 (for example, each time a document is viewed, the viewer performs signature verification).

As illustrated in FIG. 2 as an example, the i-th distributed signature generation apparatus 11 that receives, as inputs, the first key parameter and biometric information may be configured, for example, to include a key-based distributed signature generation apparatus 12 and a biometrics-based distributed signature generation apparatus 13.

The key-based distributed signature generation apparatus 12 and the biometrics-based distributed signature generation apparatus 13 may also be configured to generate distributed signatures by executing a biometrics-based two-party signature generation protocol.

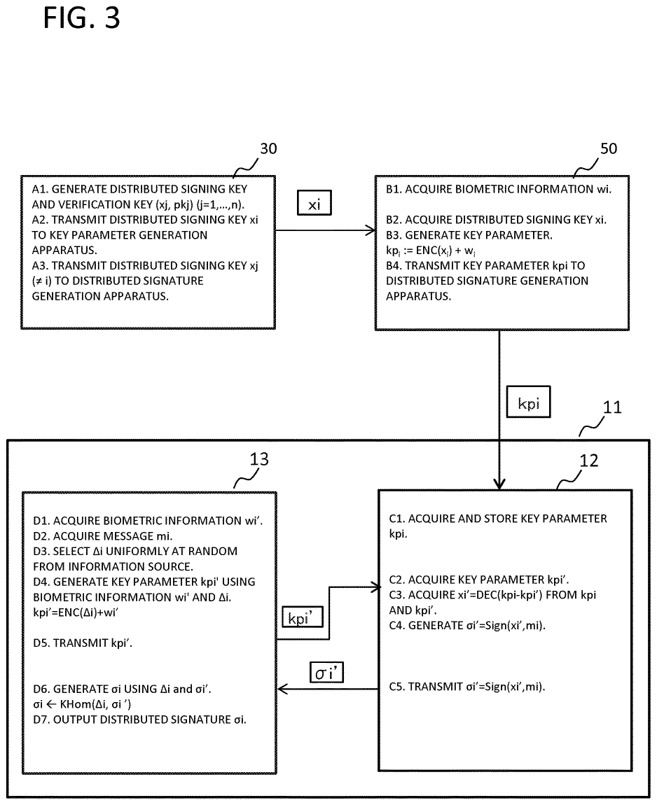

FIG. 3 illustrates an example processing performed by the key-based distributed signature generation apparatus 12 and the biometrics-based distributed signature generation apparatus 13 of the distributed signature generation apparatus 11. It is noted that FIG. 3 also illustrates an example processing performed by the distributed key generation apparatus 30 and the key parameter generation apparatus 50 for the purpose of describing the processing of the key-based distributed signature generation apparatus 12 and the biometrics-based distributed signature generation apparatus 13.

The distributed key generation apparatus 30 generates key pairs (xj, pkj) (j=1, . . . , n), where xj is a j-th distributed signing key and pkj is a j-th verification key (Step A1). The distributed key generation apparatus 30 transmits the distributed signing key xi to the key parameter generation apparatus 50 (Step A2). The distributed key generation apparatus 30 transmits the distributed signing key xj (≠i) to the distributed signature generation apparatus 10-j (Step A3).

The key parameter generation apparatus 50 acquires the biometric information wi (first biometric information) of the i-th signer i (Step B1). The key parameter generation apparatus 50 receives the distributed signing key xi transmitted from the distributed key generation apparatus 30 (Step B2). The key parameter generation apparatus 50 generates a key parameter kpi using the value obtained by encoding the distributed signing key xi with an error-correcting encoding function ENC and the biometric information wi of the i-th signer (Step B3).

$$kpi := ENC ( x i ) + w i \qquad ( 1 )$$

It is noted that the operation on the right-hand side of Equation (1) may be addition, subtraction, or bitwise exclusive OR. The key parameter defined by Equation (1) may also be referred to as a “parameter”, “helper key”, or “helper data” in some literature.

The key parameter generation apparatus 50 transmits the key parameter kpi to the distributed signature generation apparatus 11 (step B4).

In the distributed signature generation apparatus 11, the biometrics-based distributed signature generation apparatus 13 and the key-based distributed signature generation apparatus 12 generate a distributed signature σi using key parameters and biometric information using a two-party signature generation protocol. One example method may be implemented as follows. The key-based distributed signature generation apparatus 12 of the distributed signature generation apparatus 11 receives and stores (registers) the key parameter kpi (Step C1). The key parameter kpi may also be referred to as a first key parameter.

The biometrics-based distributed signature generation apparatus 13 of the distributed signature generation apparatus 11 acquires biometric information wi′ (second biometric information) (Step D1). The biometrics-based distributed signature generation apparatus 13 acquires a message mi to be signed (Step D2). The biometrics-based distributed signature generation apparatus 13 generates a differential key Δi (Step D3). For example, the differential key Δi is selected uniformly at random from the information sources. The biometrics-based distributed signature generation apparatus 13 generates a key parameter kpi′ using a value obtained by encoding the differential key Δi with an error-correcting en coding function ENC and the biometric information wi′ (Step D4).

$${kpi}^{′} := ENC ( Δ i ) + {wi}^{′} \qquad ( 2 )$$

It is noted that the key parameter kpi′ may also be referred to as the second key parameter.

The biometrics-based distributed signature generation apparatus 13 transmits the key parameter kpi′ to the key-based distributed signature generation apparatus 12 (Step D5).

The key-based distributed signature generation apparatus 12 receives the key parameter kpi′ transmitted from the biometrics-based distributed signature generation apparatus 13 (Step C2).

The key-based distributed signature generation apparatus 12 generates (recovers) a temporary signing key (auxiliary signing key) xi′ using the key parameters kpi and kpi′ (Step C3). Here, the temporary signing key (auxiliary signing key) xi′ is obtained by decrypting a difference between the key parameters kpi and kpi′ using a decryption function DEC.

In case of the linear coding, the following holds:

$${xi}^{′} := DEC ( k p i - {kpi}^{′} ) = DEC \{ ( E N C ( x i ) + w i ) - ( E N C ( Δ i ) + {wi}^{′} ) \} = DE C ( E N C ( x i ) - E N C ( Δ i ) ) + ( w i - {wi}^{′} ) \} = DEC \{ ( E N C ( x i - Δ i ) ) + ( w i - {wi}^{′} ) \} \qquad ( 3 )$$

When the biometric information wi and wi′ are close, and a distance d(wi, wi′) is less than or equal to a predetermined threshold value th, (d(wi, wi′)<=th), then from Equation (3), the following holds.

$${xi}^{′} = xi - Δ i \qquad ( 4 )$$

The threshold th may be a value such that if the distance d(wi, wi′) between the biometric information wi and wi′ is less than or equal to th, the difference between the biometric information wi and wi′ falls within an error correction capability range of the error correction code. It is noted that the distributed signing key xi itself be extracted (revealed) by the distributed cannot signature generation apparatus 11 (key-based distributed signature generation apparatus 12 and biometrics-based distributed signature generation apparatus 13).

The key-based distributed signature generation apparatus 12 generates a temporary distributed signature σi′ from the temporary signing key xi′(=xi−Δi) (Step C4).

$$σ {i}^{′} := Sign ( {xi}^{′} , mi ) \qquad ( 5 )$$

The key-based distributed signature generation apparatus 12 transmits the temporary distributed signature σi′ to the biometrics-based distributed signature generation apparatus 13 (Step C5).

The biometrics-based distributed signature generation apparatus 13 receives the temporary distributed signature σi′ from the key-based distributed signature generation apparatus 12 and generates a distributed signature σi using the temporary distributed signature σi′ and the differential key Δi (Step D6).

In the biometrics-based distributed signature generation apparatus 13, in case where the signature scheme is one such as the Schnorr signature that possesses additive homomorphism, by using the temporary signing key σ i′ generated using the differential key Δi and the message mi with the temporary signing key xi′, the key homomorphism transformation Khom may be used to convert into the signature σi (distributed signature) corresponding to the temporary signing key xi′+the differential key Δi.

$$σ i := Khom ( Δi , σ {i}^{′} ) \qquad ( 6 )$$

Regarding the key homomorphic transformation (Khom), reference may be made to, for example, Reference Literatures 5 and 6.

The biometrics-based distributed signature generation apparatus 13 outputs the generated distributed signature σi (Step D7).

It is noted that Equation (3) maybe derived based on the following equation

$$E N C ( x ) - E N C ( {x}^{′} ) = E N C ( x - {x}^{′} ) \qquad ( 7 )$$

Equation holds due to linearity of the error-correcting encoding function ENC. The error-correcting encoding function ENC converts plaintext a in a source space into a code c. The decoding function DEC converts the code c back into the plaintext a.

$$c ← E N C ( a ) \qquad ( 8 )$$

$$a ← DE C ( c ) \qquad ( 9 )$$

For any code c′ whose difference with the code c of an arbitrary plaintext a in the source space falls within an error-correcting capability, the following needs to hold

$$a = D E C ( {c}^{′} ) \qquad ( 10 )$$

In a linear coding scheme, the following holds.

$$ENC ( a 1 ) + ENC ( a 2 ) = ENC ( a 1 + a 2 ) \qquad ( 11 )$$

where ENC(a1+a2) is a ciphertext of a1+a2. That is, for example, the sum (or difference) of ciphertexts ENC(a1) and ENC(a2) of two plaintexts a1 and a2 also becomes a ciphertext, and this is equal to the ciphertext ENC(a1+a2) of the sum of a1 and a2. Accordingly, the following holds.

$$a 1 + a 2 = DEC ( E N C ( a 1 ) + E N C ( a 2 ) ) \qquad ( 12 )$$

In Equation (12), it is not needed hat the “+” signs on the left and right sides represent the same operation.

Regarding encoding, an error-correcting code (e.g., Hamming code, Bose-Chaudhuri-Hocquenghem (BCH) code, Reed-Solomon (RS) code, Low-Density Parity-Check (LDPC) code) may be used. Alternatively, lattice coding may be employed. More specifically, a scheme utilizing integer lattice or triangular lattice may be used, as well as more complex lattice (e.g., Reference Literature 7). Furthermore, when biometric information is facial information similar or N-dimensional vectors (feature vectors) (where wi and wi′ are N-dimensional feature vectors), where xi may be a value assigned to a randomly selected N-dimensional integer lattice point (in a space spanned by N basis vectors) (Patent Literature 1), the encoding function ENC(xi) may be defined as a function returns a vector corresponding to the lattice coordinate of that integer lattice point with xi assigned thereto, and the decoding function DEC (c) may be defined as a function that restores xi from the vector c. A process of randomly selecting a plaintext may involve selecting a random codeword c and DEC(c) may return a random plaintext.

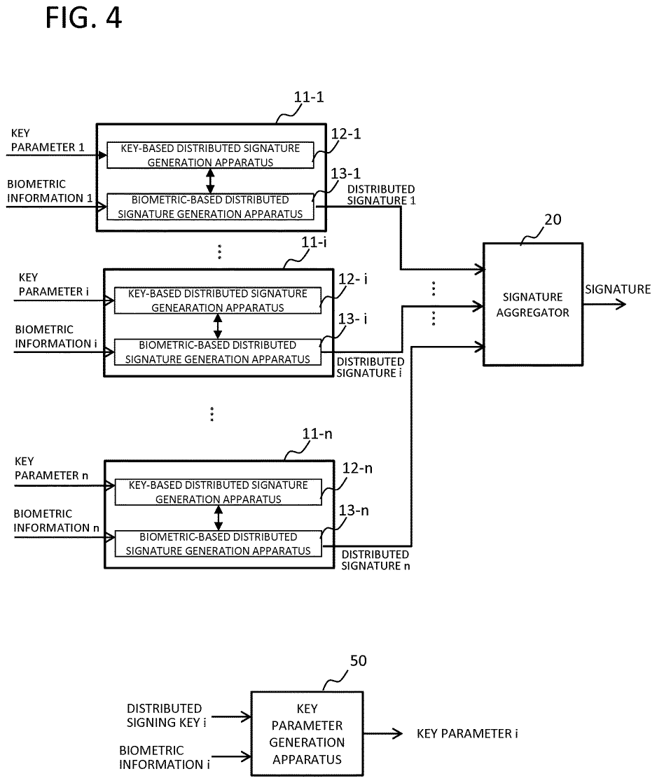

FIG. 4 illustrates a configuration where all n−1 distributed signature generation apparatuses 10-1 to 10-n in FIG. 1 are replaced by the distributed signature generation apparatuses 11, each of which is configured to generate distributed signatures using key parameters and biometric information. Referring to FIG. 4, the distributed signature generation apparatus 11-i (i=1, . . . , n) includes a key-based distributed signature generation apparatus 12-i and a biometrics-based distributed signature generation apparatus 13-i. The key-based distributed signature generation apparatus 12-i (i=1, . . . , n) and the biometrics-based distributed signature generation apparatus 13-i (i=1, . . . , n) may be constituted by the key-based distributed signature generation apparatus 12 and the biometrics-based distributed signature generation apparatus 13, as described with reference to FIGS. 2 and 3. The key parameter generation apparatus 50 generates key parameters kpi using the distributed signing keys xi and biometric information wi (i=1, . . . , n) generated by the distributed key generation apparatus 30, then outputs the generated key parameter kpi to the corresponding distributed signature generation apparatus 11-i. In FIG. 4, at least one of the key-based distributed signature generation apparatus 12-i of the n distributed signature generation apparatuses 11-1 to 11-n may be configured to include the key parameter generation apparatus 50. In this case, it is preferable that the key parameter generation apparatus 50 generates the key parameter kpi, registers the key parameter in the key-based distributed signature generation apparatus 12-i, and then immediately deletes the key parameter. The key parameter generation apparatus 50 may generate n key parameters kpi (i=1, . . . , n) by repeating this key parameter generation process n times for each of the n distributed signature generation apparatuses 11-1 to 11-n. The key parameter generation apparatus 50 may receive n pieces of biometric information w1 to wn, acquired individually for each of the n signers at the signer's terminal (not illustrated), via a secure network (not illustrated), and then synthesizes respectively the biometric information with the corresponding distributed signing keys to generate n key parameters kpi (i=1, . . . , n). In the distributed signature generation apparatus 11-i (where i is any value from 1 to n), if the key parameters do not exist at the time of generating a distributed signature, and signer whose biometric information is to be used for the distributed signature is absent, the distributed signature cannot be generated. If a distributed signature is fraudulently generated by someone other than the signer, the signature generated by aggregating the n distributed signatures would be rejected upon verification. Alternatively, the configuration may be such that k (1<k<n−1) distributed signature generation apparatuses out of the n−1 distributed signature generation apparatuses 10-1 to 10-n illustrated in FIG. 1 may be replaced by the distributed signature generation apparatuses 11, each of which generates distributed signatures using key parameters and biometric information.

The system in FIG. 2 may be configured based on an aggregate signature scheme, for example. The following describes an example embodiment with a configuration based on an aggregate signature using a BLS (Boneh-Lynn-Shacham) signature (Reference Literature 1). First, the BLS signature scheme is described.

Let P₀ be a base point on an elliptic curve defined over a finite field Fₚ of prime number p, with order r (rP₀=0). Then G₀:={0, P₀, 2P₀, . . . , (r−1)P₀} constitutes an additive cyclic group of order r. Similarly, for another base point P₁ on an elliptic curve (rP₁=0), G₁:={0, P₁, 2P₁, . . . , (r−1)P₁} also constitutes an additive cyclic group of order r.

$$e : {G}_{0} \times {G}_{1} \to {G}_{T} \qquad ( 13 a )$$

is a multiplicative cyclic group of order r generated by e(P₀, P₁) (called a pairing). For any integers a, b and points P∈G₀, Q∈G₁,

$$e ( aP , bQ ) = e ( a bP , Q ) = e ( P , abQ ) = e ( P , Q ) ab \qquad ( 13 b )$$

holds (bilinearity).

The same applies, but the following notation will be used below. Let g₀ and g₁ be generators (of order r) of the multiplicative groups G₀ and G₁.

$$e : {G}_{0} \times {G}_{1} \to {G}_{T} \qquad ( 14 a )$$

is a multiplicative cyclic group of order r generated by e(g₀, g₁). For any integers a, b and points g₀∈G₀, g₁∈G₁,

$$e ( {g}_{0} \hat{} a , {g}_{1} \hat{} b ) = e ( {g}_{0} \hat{} ( ab ) , {g}_{1} ) = e ( {g}_{0} , {g}_{1} \hat{} ( ab ) ) = e ( {g}_{0} , {g}_{1} ) \hat{} ( ab ) \qquad ( 14 b )$$

holds (\hat{ } denotes an exponentiation operator).

A hash function H₀ is defined as follows:

$${H}_{0} : M \to {G}_{0}$$

### Key Generation:

A key generation function KeyGen selects S uniformly at random from the finite field Fr. This is denoted below using the operation symbol “←^{R}”.

$$s {←}^{R} {F}_{r} \qquad ( 15 )$$

Key Gen generates the verification key (public key) pk.

$$pk := {g}_{1} \hat{} s \qquad ( 16 )$$

It is noted that here is also a notation pk:=sG using the base point G on the elliptic curve.
KeyGen generates a signing key sk.

$$sk := s \qquad ( 17 )$$

Key Gen outputs (sk, pk) (return as the return value).

### Signature Generation:

A signature function Sign(sk, m) generates a signature σ using the hash value H₀(m) of a message m to be signed and the signing key s.

$$σ := {H}_{0} ( m ) \hat{} s ∈ {G}_{0} \qquad ( 18 )$$

Sign(sk, m) returns the signature σ as a return value.

It is noted that the signature may be denoted as σ:=sH₀(m)∈G₀.

### Signature Verification:

A verification function Verify (pk, m, σ) computes the hash value H₀(m) of the message m taken as an input argument, computes e (pk, H₀(m)) which is a pairing of H₀(m) and the verification key pk, and computes e(g₁, σ) which is a pairing of the signature σ taken as an input argument and the generator g₁ to verify whether these pairings match.

$$If e ( p k , {H}_{0} ( m ) ) = e ( {g}_{1} , σ ) , \qquad ( 19 )$$

holds, Verify (pk, m, σ) returns 1 (accepted) as a return value, else (otherwise), returns 0 (rejected) as the return value.

In the verification using Equation (19), if the set of the message m and the signature σ is correct, from

$$e ( p k , {H}_{0} ( m ) ) = e ( {g}_{1} \hat{} s , {H}_{0} ( m ) ) = e ( {g}_{1} , {H}_{0} ( m ) \hat{} s ) = e ( {g}_{1} , σ ) \qquad ( 20 )$$

it is confirmed that Equation (19) holds.

The present disclosure next describes an aggregate signature scheme using the BLS signature scheme.

For each triplet (pki, mi, σᵢ) (i=1, . . . n) consisting of the verification key pki, the message mi to be signed, and the signature σᵢ (distributed signature), n signatures σᵢ may be combined to generate a single short signature (aggregate signature) σ.

$${σ}_{i} := {H}_{0} ( m i ) \hat{} s ∈ {G}_{0} \qquad ( 21 )$$

More specifically, the signature aggregator 20 of FIG. 2 executes the following,

$$σ ← {σ}_{1} … {σ}_{n} ∈ {G}_{0} \qquad ( 22 )$$

The signature verification apparatus 40 performs verification of the aggregate signature σ∈G₀, for example, by verifying whether

$$e ( p k , σ ) = e ( p k 1 , {H}_{0} ( {m}_{1} ) ) … e ( p {k}_{n} , {H}_{0} ( {m}_{n} ) ) \qquad ( 23 )$$

holds.

When the message to be signed is identical (m₁==mₙ=m), in the signature verification apparatus 40 may perform verification by checking whether

$$e ( p k , σ ) = e ( p {k}_{1} … p {k}_{n} , {H}_{0} ( m ) ) \qquad ( 24 )$$

holds.

In Reference Literature 1, a modified BLS aggregate signature scheme is disclosed to cope with “rogue public key attack”

A second hash function H₀ is introduced.

$${H}_{0} : {G}_{0}^{n} \to {R}^{n} ( R := 1 , 2 , … , {2}^{128} ) \qquad ( 25 )$$

Key generation and signature generation are the same as the BLS described above.

The signature aggregator 20 obtains n pairs of verification keys pki and the distributed signatures σᵢ (i=1, . . . , n):

$$( ( p {k}_{1} , {σ}_{1} ) , … , ( p {k}_{n} , {σ}_{n} ) ) , \qquad ( 26 )$$

$$computes ( {t}_{1} , … , {t}_{n} ) := {H}_{0} ( p {k}_{1} , … , p {k}_{n} ) ∈ {R}^{n} , \qquad ( 27 )$$

generates the aggregate signature

$$σ := {\prod }_{i = 1}^{n} {σ}_{i}^{{t}_{i}} , \qquad ( 28 )$$

and outputs the aggregate signature σ to the signature verification apparatus 40.

The signature verification apparatus 40 computes

$$( {t}_{1} , … , {t}_{n} ) := {H}_{0} ( p {k}_{1} , … , p {k}_{n} ) ∈ {R}^{n} \qquad ( 29 )$$

The signature verification apparatus 40 computes an aggregate verification key apk.

$$apk := {\prod }_{i = 1}^{n} p {k}_{i}^{{t}_{i}} \qquad ( 30 )$$

The signature verification apparatus 40 verifies the aggregate signature σ using the aggregate verification key apk.

$$if e ( apk , {H}_{0} ( m ) ) = e ( {g}_{1} , σ ) , \qquad ( 31 )$$

the verification function Verify (apk, m, σ) returns 1 (accepted), otherwise, returns 0 (reject) as a return value.

In the verification using Equation (31), if a set of the message m and the signature σ is correct, then

$$\begin{matrix}e ( apk , {H}_{0} ( m ) ) = e ( {\prod }_{i = 1}^{n} p {k}_{i}^{{t}_{i}} , {H}_{0} ( m ) ) \\ = e ( {g}_{1} \hat{} ( {\sum }_{i = 1}^{n} {s}_{i}^{{t}_{i}} ) , {H}_{0} ( m ) ) \\ = e ( {g}_{1} , {H}_{0} ( m ) \hat{} ( {\sum }_{i = 1}^{n} {s}_{i}^{{t}_{i}} ) ) \\ = e ( {g}_{1} , {\prod }_{i = 1}^{n} {σ}_{i}^{{t}_{i}} ) \\ = e ( {g}_{1} , σ )\end{matrix} \qquad ( 32 )$$

holds, and Equation (31) is satisfied.

In FIG. 2, the key-based distributed signature generation apparatus 12 of the distributed signature generation apparatus 11 obtains the key parameter (first key parameter) kpi from the key parameter generation apparatus 50 and stores (registers) the key parameter in a storage part (not illustrated). The key parameter kpi is computed using the biometric information wi of the i-th signer and an encoded value of the distributed signing key si encoded with an error-correcting encoding function ENC.

$$kpi := ENC ( s i ) + w i \qquad ( 33 )$$

The biometrics-based distributed signature generation apparatus 13 acquires the signer's biometric information wi′.

The biometrics-based distributed signature generation apparatus 13 selects Δi uniformly at random from a finite field Fr.

$${\begin{matrix}Δ i {←}^{R} F & ( 34 )\end{matrix}}^{R}$$

generates the second key parameter kpi′ using an encoded value of Δi encoded with the error-correcting encoding function ENC and the second biometric information wi′.

$${kpi}^{′} := ENC ( Δ i ) + {wi}^{′} \qquad ( 35 )$$

The biometrics-based distributed signature generation apparatus 13 transmits the second key parameter kpi′ to the key-based distributed signature generation apparatus 12. The biometrics-based distributed signature generation apparatus 13 may also transmit the message m to be signed to the key-based distributed signature generation apparatus 12. Alternatively, in the distributed signature generation apparatus 11, the message m to be signed may be accessible to both the biometrics-based distributed signature generation apparatus 13 and the key-based distributed signature generation apparatus 12. In this case, transmission of the message m to be signed from the biometrics-based distributed signature generation apparatus 13 to the key-based distributed signature generation apparatus 12 is not required. Alternatively, H₀(m) may be transmitted from the biometrics-based distributed signature generation apparatus 13 to the key-based distributed signature generation apparatus 12, where the key-based distributed signature generation apparatus 12 generates a temporary distributed signature. That is, the key-based distributed signature generation apparatus 12 generates a temporary distributed signature using H₀(m) received from the biometrics-based distributed signature generation apparatus 13, without acquiring the message m itself.

The key-based distributed signature generation apparatus 12 generates a temporary signing key (auxiliary signing key) si′ using the first key parameter kpi and the second key parameter kpi′. In a linear code, the following holds.

$${si}^{′} := DEC ( kpi - {kpi}^{′} ) = DEC \{ ( ENC ( si ) + wi ) - ( E N C ( Δ i ) + {wi}^{′} ) \} = DEC ( ENC ( s i ) - ENC ( Δ i ) ) + ( w i - {wi}^{′} ) \} = DEC \{ ( ENC ( si - Δ i ) ) + ( w i - {wi}^{′} ) \} \qquad ( 36 )$$

From Equation (36), if the biometric information wi is close to wi′, that is, a distance d(wi, wi′) is less than or equal to a predetermined threshold th (d(wi, wi′)<=th), the following holds.

$${si}^{′} = si - Δ i \qquad ( 37 )$$

It is noted that the distributed signing key si itself cannot be extracted by the key-based distributed signature generation apparatus 12 or the biometrics-based distributed signature generation apparatus 13.

The key-based distributed signature generation apparatus 12 generates a temporary distributed signature σi′ using the temporary signing key si′(=si−Δi).

$$σ {i}^{′} := Ho ( m ) \hat{} {si}^{′} ∈ {G}_{0} \qquad ( 38 )$$

The key-based distributed signature generation apparatus 12 transmits the temporary distributed signature σ i′ to the biometrics-based distributed signature generation apparatus 13. The key-based distributed signature generation apparatus 12 may also transmit H₀(m) along with the temporary distributed signature σ i′ to the biometrics-based distributed signature generation apparatus 13.

The biometrics-based distributed signature generation apparatus 13 receives the temporary distributed signature σi′ from the key-based distributed signature generation apparatus 12 and generates a distributed signature σi using the differential key Δi. For example, the biometrics-based distributed signature generation apparatus 13 may, generate, using the differential key Δi and H₀(m),

$${H}_{0} ( m ) \hat{} Δ i ∈ {G}_{0} , \qquad ( 39 )$$

and combine H₀(m)\hat{ }Δi with the temporary distributed signature σi′ to produce the distributed signature σi. σi:=σi′·H₀(m)\hat{ }Δi=H₀(m)\hat{ }si′·H₀(m)\hat{ }Δi=H₀(m)\hat{ }

$$( {si}^{′} + Δ i ) ∈ {G}_{0} \qquad ( 40 )$$

The distributed signature σi in Equation (40) is given by

$$σ i := {H}_{0} ( m ) \hat{} ( {si}^{′} + Δ i ) = {H}_{0} ( m ) \hat{} si ∈ {G}_{0} \qquad ( 41 )$$

and it can be seen that this is equivalent to the signature of the message m using the distributed signing key si. In the key-based distributed signature generation apparatus 12 and the biometrics-based distributed signature generation apparatus 13, the distributed signing key si is never revealed.

The i-th distributed signature σi is an invalid distributed signature that does not correspond to the distributed signing key xi if, for example, something other than the biometric information of the i-th signer used to generate the key parameter kpi is used. Verification of the aggregate signature containing this invalid distributed signature will be rejected.

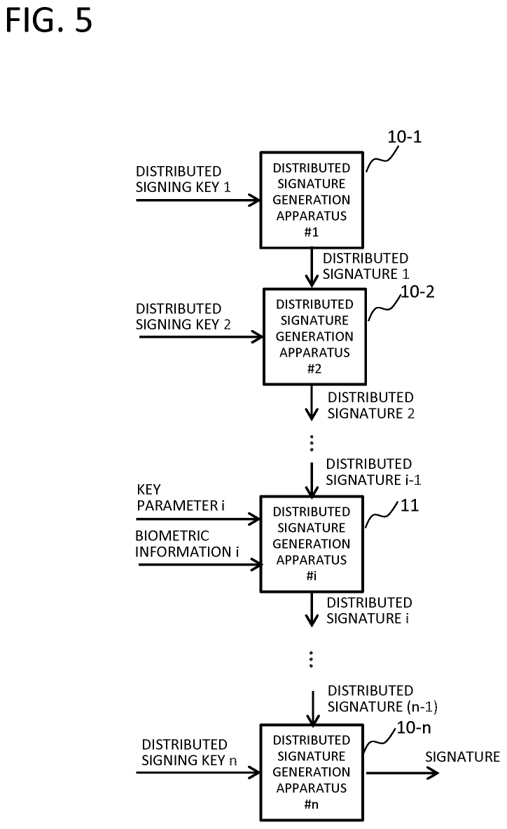

FIG. 5 is an example illustrating an instance based on sequential aggregate signatures as one example embodiment of the present disclosure. Referring to FIG. 5, a distributed signature generation apparatus 10-1 generates a distributed signature 1 for a message to be signed based on a distributed signing key 1 and transmits the distributed signature to a distributed signature generation apparatus 10-2. A distributed signature generation apparatus 10-n receives a distributed signature n−1 from a distributed signature generation apparatus 10-(n−1) (not illustrated), generates a distributed signature n for the message to be signed based on a distributed signing key n, and transmits the distributed signature n as a signature to a signature verification apparatus (not illustrated). In FIG. 5, at least one distributed signature generation signature 11 is positioned as the distributed signature generation apparatus 10-i at the i-th position. The key-based distributed signature generation apparatus 12 of the distributed signature generation apparatus 11 receives the key parameter kpi, generated using the corresponding distributed signing key and biometric information, from an unillustrated key parameter generation apparatus and stores the key parameter in an unillustrated storage part.

In a sequential aggregate signature scheme, key generation and verification may be identical to those of a standard or normal signature scheme. The n-th signer executes the signature function (Seq Sign), receives the previously generated aggregate signature \tilde{σ}ₙ₋₁, the corresponding messages m₁, . . . , mₙ₋₁, the verification keys pk₁, . . . , pkₙ₋₁, the signing key skₙ, and the message mₙ, and outputs a new aggregate signature σn. When n=1, this becomes the standard signature process.

In the signing phase (signature generation), the distributed signature generation apparatus 11 receives the (i−1)th distributed signature i−1 (\tilde{σ}ᵢ₋₁) generated by the distributed signature generation apparatus 10-(i−1) (not illustrated). The distributed signature generation apparatus 11 acquires the biometric information wi′ and generates the i-th distributed signature (\tilde{σ}ᵢ) from the biometric information wi′, the distributed signature i−1, and the stored key parameter. Here, the biometrics-based distributed signature generation apparatus 13 of the distributed signature generation apparatus 11 acquires the biometric information wi′, further generates a differential key Δi, and uses Δi and the biometric information wi′ to generate a key parameter kpi′ which is then transmitted to the key-based distributed signature generation apparatus 12. The key-based distributed signature generation apparatus 12 generates a temporary distributed signing key using the key parameters kpi and kpi′, thereby generating a temporary distributed signature σᵢ′. The biometrics-based distributed signature generation apparatus 13 uses the differential key Δi for the temporary distributed signature σᵢ′ to generate the i-th distributed signature i (\tilde{σ}ᵢ) from the (i−1)th distributed signature i−1 (\tilde{σ}ᵢ₋₁) generated by the unillustrated distributed signature generation apparatus 10-(i−1).

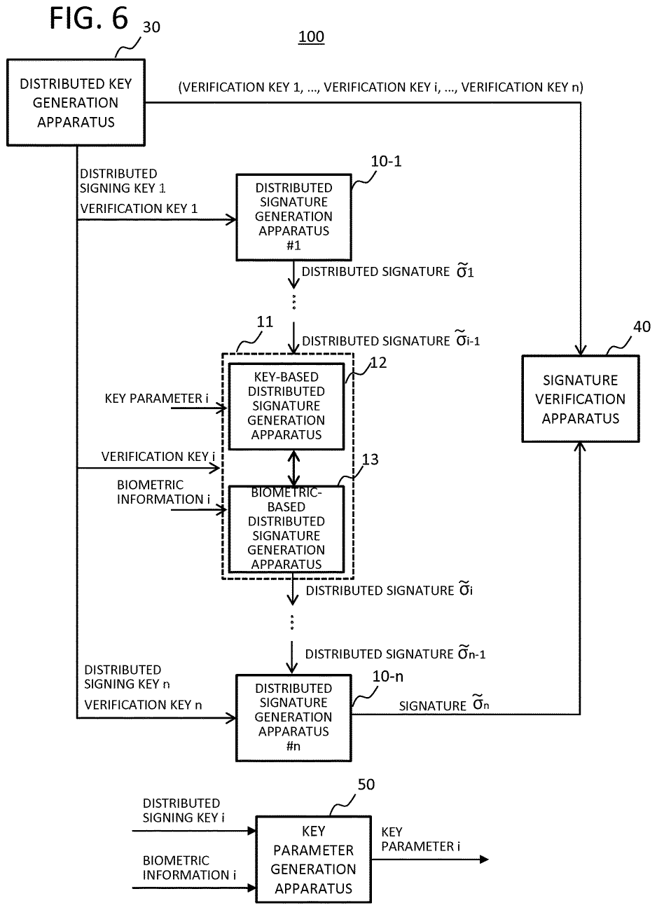

FIG. 6 is a schematic diagram illustrating an example signature system 100 including the configuration illustrated in FIG. 5. Referring to FIG. 6, the distributed key generation apparatus 30 generates a set of distributed signing keys and verification keys (xj, vj) (j=1, . . . , n), transmits the distributed signing key xi to the key parameter generation apparatus 50, and transmits the distributed signing key xj (i) to the distributed signature generation apparatus 10-j. The key parameter generation apparatus 50 acquires the biometric information wi (first biometric information) of the i-th signer i, acquires the distributed signing key xi, and generates the key parameter kpi using the value obtained by encoding the distributed signing key xi with the error-correcting encoding function ENC and the biometric information wi of the i-th signer. The signature apparatus 40 receives the distributed verification signing key n (On) output from the distributed signature generation apparatus 10-n and performs signature verification.

The following describes an example system based on a Schnorr signature scheme as one type of a sequential aggregate signature scheme (Reference Literature 2). First, an overview of a Schnorr signature scheme is provided.

### Setup:

A setup function Setup (1^{κ}) selects a group G over a prime p of order κ bits (where κ is a security parameter), selects g uniformly at random from G (g←^{R}G), and selects a hash function H:G×{0, 1}*←{0, 1} uniformly at random from a hash function family {Hₖ}ₖ, and sets (G, g, H) as a public parameter pp.

### Key Generation:

A key generation function KeyGen generates a signing key (secret key) and a verification key according to the public parameter pp. That is, x is selected uniformly at random from Zp (a set of integers greater than or equal to 0 and less than p(=Z/pZ)) (x←^{R}Zp), and derives the verification key (public key) X from x.

$$X := g \hat{} x \qquad ( 42 )$$

The verification key and signing key are determined and output as follows.

$$signing key : sk := x \qquad ( 43 )$$

$$verification key : p k := X \qquad ( 44 )$$

### Signature Generation:

A signature function Sign(sk, m) sets sk taken as input, the signing key x, selects r uniformly at random from Zp, obtains a nonce R, computes, as a challenge, a hash value of a concatenated value of R and a message m taken as input, computes s (signature) using r, the challenge c, and the signing key x, and sets a pair (R, s) as a signature σ.

$$x := sk \qquad ( 45 )$$

$$r {←}^{R} Zp \qquad ( 46 )$$

$$R := g \hat{} r \qquad ( 47 )$$

$$c := H ( R , m ) \qquad ( 48 )$$

$$s := r + cx mod p \qquad ( 49 )$$

$$σ := ( R , s ) \qquad ( 50 )$$

The signature function Sign(sk, m) outputs (returns as its return value) the signature σ=(R, s). It is noted that mod denotes a modulo operator.

### Signature Verification:

A verification function Verify (pk, m, σ) sets pk taken as input to a verification key X,

$$X := p k \qquad ( 51 )$$

computes (R,s) from σ taken as input

$$( R , s ) := σ \qquad ( 52 )$$

computes a challenge c as a hash value of R and a message m taken as input, and if

$$c := H ( R , m ) \qquad ( 53 )$$

$${g}^{s} = R {X}^{c} \qquad ( 54 )$$

hold, returns (outputs) 1 (accepted) as a return value, else, returns (outputs) 0 (reject) as a return value.

In the verification using Equation (54), if a set of the signature σ and the message m is valid, then

$$R {X}^{c} = {g}^{r} p {k}^{c} = {{g}^{r} ( {g}^{x} )}^{c} = {g}^{( r + cx )} = {g}^{s} \qquad ( 55 )$$

holds, which confirms that Equation (54) is satisfied.

Next, an example of sequential aggregate signature scheme based on Schnorr signature algorithm is described below (Reference Literature 2).

### Key Generation:

A key generation function KeyGen generates n pairs (ski, pki) (i=1, . . . , n). Each of the n signers may generate their own (ski, pki) pairs on their respective terminals.

### Signature Generation:

Each of the distributed signature generation apparatuses #2 to #n illustrated in FIG. 6, executes a sequential aggregate signature function (Seqsign). The first distributed signature generation apparatus #1 outputs a generated signature \tilde{σ}1 to the second distributed signature generation apparatus #2. The second and subsequent distributed signature generation apparatus #2 executes the sequential aggregation signature function (Seqsign). For simplicity of description, the following describes processing of the n-th distributed signature generation apparatus 10-n. The n-th distributed signature generation apparatus 10-n executes the following sequential aggregation signature function Seqsign.

The sequential aggregate signature function Seqsign of the n-th distributed signature generation apparatus 10-n takes ((pk₁, m₁), . . . , (pkₙ₋₁, mₙ₋₁), \tilde{σ}ₙ₋₁, skₙ, mₙ) as input arguments and performs the following processing.

Seqsign receives as an input argument, the signature \tilde{σ}ₙ₋₁ generated by the (n−1)th distributed signature generation apparatus 10-(n−1), and set \tilde{R}ₙ₋₁ and the n−1 distributed signature {s₁, . . . , sₙ₋₁} as internal variables.

$$( {\tilde{R}}_{n - 1} , \{ {s}_{1} , … , {s}_{n - 1} \} ) := {\tilde{σ}}_{n - 1} \qquad ( 56 )$$

Seqsign sets the secret key skn taken as input to the n-th signing key xn and obtain the verification key Xn.

$${x}_{n} := {sk}_{n} , \qquad ( 57 )$$

$${X}_{n} := g \hat{} xn$$

Seqsign generates rₙ uniformly at random.

$${r}_{n} {←}^{R} Zp \qquad ( 58 )$$

Seqsign computes a commitment using rₙ.

$${R}_{n} := g \hat{} {r}_{n} \qquad ( 59 )$$

Seqsign determines the n-th \tilde{R}ₙ from the (n−1)th \tilde{R}ₙ₋₁ and Rₙ.

$${\tilde{R}}_{n} = {\tilde{R}}_{n - 1} \cdot {R}_{n} \qquad ( 60 )$$

Seqsign computes a hash value of \tilde{R}ₙ, the verification key Xₙ, the message mₙ, the signature sₙ₋₁, and n, and use the hash value as a challenge c for the signature.

$${c}_{n} := H ( {\tilde{R}}_{n} , {X}_{n} , {m}_{n} , {s}_{n - 1} , n ) \qquad ( 61 )$$

Seqsign computes the n-th Schnorr signature sₙ.

$${s}_{n} := {r}_{n} + {c}_{n} \cdot {x}_{n} \qquad ( 62 )$$

The n-th distributed signature generation apparatus 10-n generates a signature

$${\tilde{σ}}_{n} := ( {\tilde{R}}_{nn} , \{ {s}_{1} , … , {s}_{n - 1} , {s}_{n} \} ) \qquad ( 63 )$$

and outputs the signature as a signature σ to the signature verification apparatus 40.

### Signature Verification:

A signature verification apparatus 40 verifies the signature using a verification function Vf ({(pk₁, m₁), . . . , pkₙ, mₙ), \tilde{σ}ₙ).

The verification function Vf takes, as input, n pairs of the verification keys and the messages {(pk₁, m₁), . . . , pkₙ, mₙ), along with the signature σ=In.

Vf computes each verification key Xᵢ:=pkᵢ (i=1, . . . , n) and set (\tilde{R}ₙ, {s₁, . . . , sₙ₋₁, sₙ}) from \tilde{σ}ₙ.

Vf computes the hash values of \tilde{R}ₙ, Xₙ, mₙ, sₙ₋₁, and n, then compute a challenge cₙ (corresponding to Equation (61)).

$${c}_{n} := H ( {\tilde{R}}_{n} , {X}_{n} , {m}_{n} , {s}_{n - 1} , n ) \qquad ( 64 )$$

For n=1, if

$$g \hat{} {s}_{1} = {\tilde{R}}_{1} {X}_{1} \hat{} {c}_{1} \qquad ( 65 )$$

holds, Vf returns 1 (accepted) as a return value, else (if not), returns 0 (rejected) as the return value.
For n>1, as in

$${R}_{n} := g \hat{} {s}_{n} / {X}_{n} \hat{} {c}_{n} \qquad ( 66 )$$

$${\tilde{R}}_{n - 1} := {\tilde{R}}_{n} / {R}_{n} \qquad ( 67 )$$

$${\tilde{σ}}_{n - 1} := ( {\tilde{R}}_{n - 1} , \{ {s}_{1} , … , {s}_{n - 1} \} ) , \qquad ( 68 )$$

$$verification function Vf ( \{ ( p {k}_{1} , {m}_{1} ) , … p {k}_{n - 1} , {m}_{n - 1} ) \} , {\tilde{σ}}_{n - 1} ) \qquad ( 69 )$$

may also be called recursively (Reference Literature 2).

In the sequential verification of the aggregate signature, commitment R ma y b e sequentially reconstructed from the n-th signature to the first signature. Given the j-th commitment Rⱼ, the signature verification apparatus 40 computes the challenge cⱼ and obtains the j-th commitment Rⱼ in

$${R}_{j} := g \hat{} {s}_{j} / {X}_{j} \hat{} {c}_{j} , \qquad ( 70 )$$

then obtains Rⱼ₋₁ and sequentially continues this procedure. The above procedure, the verification function Vf is denoted as a recursive function. The j-th distributed signature generation apparatus may send Rⱼ and sⱼ to the next distributed signature generation apparatus and send Xⱼ, mⱼ, and sⱼ to the signature verification apparatus 40. It is noted that the first signer sets so to the value 0 (where n=1 for sₙ₋₁).

In FIG. 6, the i-th distributed signature generation apparatus 11 includes a key-based distributed signature generation apparatus 12 and a biometrics-based distributed signature generation apparatus 13. The key-based distributed signature generation apparatus 12 obtains a first key parameter pki from a key parameter generation apparatus 50 (not illustrated) and stores (registers) the key parameter in a storage part (not illustrated). The key parameter generation apparatus 50 computes the first key parameter kpi using the correction encoding function ENC from the biometric information wi of the i-th signer and the distributed signing key xi of the i-th signer.

$$kpi := ENC ( x i ) + w i \qquad ( 71 )$$

In the biometrics-based distributed signature generation apparatus 13 takes as input õᵢ₋₁ that the distributed signature generation apparatus 10-I receives from the distributed signature generation apparatus 10-(i−1).

The biometrics-based distributed signature acquires the biometric generation apparatus 13 information wi′, selects Δi uniformly at random from finite field Fₚ, and generates a second key parameter kpi′.

$${kpi}^{′} := ENC ( Δ i ) + {wi}^{′} \qquad ( 72 )$$

The biometrics-based distributed signature generation apparatus 13 transmits the second key parameter kpi′ to the key-based distributed signature generation apparatus 12. The key-based distributed signature generation apparatus 12 generates a temporary signing key xi′ from the first key parameter kpi and the second key parameter kpi′.

$${xi}^{′} := DEC ( kpi - {kpi}^{′} ) = DEC \{ ( ENC ( xi ) + wi ) - ( ENC ( Δ i ) + {wi}^{′} ) \} = DEC ( ENC ( xi ) - E N C ( Δ i ) ) + ( wi - {wi}^{′} ) \} = DEC \{ ( ENC ( x i - Δ i ) ) + ( wi - {wi}^{′} ) \} \qquad ( 73 )$$

In Equation (73), if the biometric information wi is close to wi′, i.e., a distance d(wi, wi′) is less than or equal to a predetermined threshold th (d(wi, wi′)<=th), the following holds.

$${xi}^{′} = xi - Δ i \qquad ( 74 )$$

The distributed signing key xi is not revealed (cannot be extracted) in either the key-based distributed signature generation apparatus 12 the biometrics-based distributed signature generation apparatus 13.

The key-based distributed signature generation apparatus 12 generates a temporary distributed signature σi′ for the message to be signed using xi′(=xi−Δi) as follows.

Generate a verification key Xi corresponding to the temporary signing key xi′.

$${X}_{i} := g \hat{} {x}_{i}^{′} \qquad ( 75 )$$

Generate rᵢ uniformly at random, generate Rⱼ, and compute \tilde{R}ᵢ from \tilde{R}ᵢ₋₁ and Rⱼ received from the (i−1)th distributed signature generation apparatus 10-(i−1).

$${r}_{i} {←}^{R} Zp \qquad ( 76 )$$

$${R}_{i} := g \hat{} ri \qquad ( 77 )$$

$${\tilde{R}}_{i} {=}^{\sim} {R}_{i - 1} \cdot {R}_{i} \qquad ( 78 )$$

Determine a challenge cᵢ used for signing.

$${c}_{i} := H ( {\tilde{R}}_{i} , {X}_{i} , {m}_{i} , {s}_{i - 1} , i ) \qquad ( 79 )$$

$${si}^{′} := ri + ci \cdot {xi}^{′} \qquad ( 80 )$$

$${σ}_{i}^{′} = ( {R}_{i} , {s}_{i}^{′} ) \qquad ( 81 )$$

The key-based distributed signature generation distributed apparatus 12 transmits the temporary signature σᵢ′=(Rᵢ, sᵢ′) to the biometrics-based distributed signature generation apparatus 13.

The biometrics-based distributed signature generation apparatus 13 may generate a signature σi=(Rᵢ, sᵢ) using a distributed signing key xi(=xi′+Δi), for example, by employing a key homomorphic transformation Khom:

$${σ}_{i} := Khom ( {Δ}_{i} , {σ}_{i}^{′} ) . \qquad ( 82 )$$

The biometrics-based distributed signature generation apparatus 13 may receive σᵢ′=(Rᵢ, sᵢ′) and the challenge cᵢ from the key-based distributed signature generation apparatus 12, computes cᵢ·Δᵢ, add cᵢ·Δᵢ to sᵢ′ to generate sᵢ.

$${s}_{i} = {c}_{i} \cdot {Δ}_{i} + ( {r}_{i} + {c}_{i} \cdot {x}_{i}^{′} ) = {r}_{i} + {c}_{i} \cdot ( {Δ}_{i} + {x}_{i}^{′} ) = {r}_{i} + {c}_{i} \cdot {x}_{i} \qquad ( 83 )$$

The distributed signature generation apparatus 13 outputs the i-th distributed signature \tilde{σ}ᵢ′:=(^{~}Rₙ, {s₁, . . . , sᵢ}) to the (i+1)th distributed signature generation apparatus 10-(i+1).

If the i-th distributed signature \tilde{σ}ᵢ is generated in the distributed signature generation apparatus 11 based on biometric information other than that of the i-th signer, for example, it becomes an invalid distributed signature that does not correspond to the i-th distributed signing key xi. In such a case, the signature \tilde{σ}ₙ=σ based on this invalid distributed signature is rejected during verification.

In FIGS. 5 and 6, the distributed signature generation apparatus 11 may be replaced by (n−1) distributed signature generation apparatuses 10-1 to 10-n, and may be configured with n distributed signature generation apparatuses 11-1 to 11-n. The key parameter generation apparatus 50 inputs the distributed signing keys x1 to xn generated by the distributed key generation apparatus 30, inputs the biometric information w1 to wn of the n signers, generates key parameters kp1 to kpn, and outputs the key parameters kp1, . . . , kpn to the distributed signature generation apparatuses 11-1 to 11-n respectively. The key parameter generation apparatus 50 may receive the biometric information w1 to wn of n signers acquired respectively on sides of signer's terminals (not illustrated) via a secure network(s) (not illustrated).

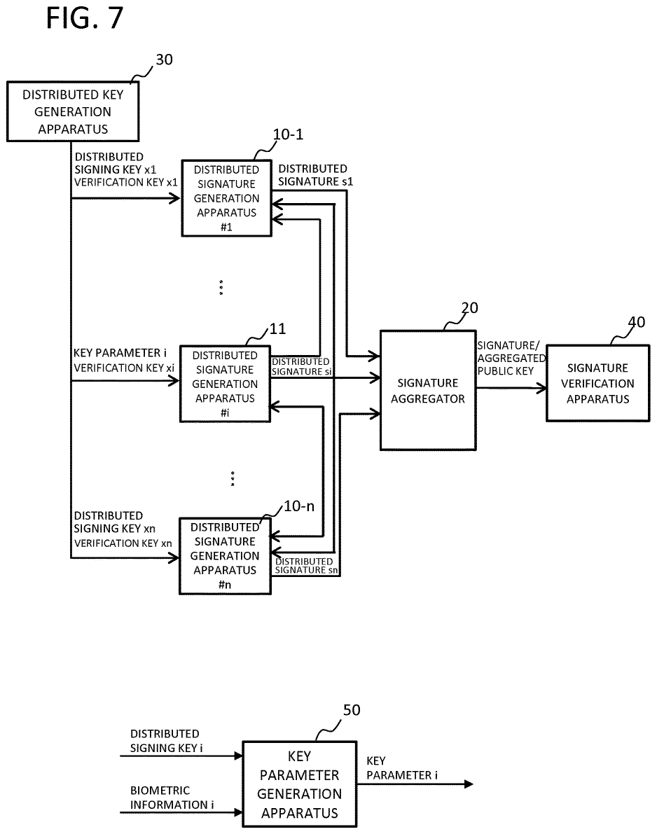

FIG. 7 is a diagram illustrating a signature system according to one of example embodiments of the present disclosure. The configuration illustrated in FIG. 7 involves a signer (distributed signature generation apparatus) exchanging information (e.g., broadcasting) for signature generation in a key generation stage and a signing stage. The distributed key generation apparatus may be configured such that multiple signers generate pairs of distributed signing keys and verification keys at respective terminals of the signers. The signer's terminal and the distributed signature generation apparatus 10 may be integrated. The configuration May also involve transmitting the i-th distributed signing key i(xi), corresponding to at least one distributed signature generation apparatus 11 (the i-th distributed signature generation apparatus), to the key parameter generation apparatus 50. The basic operation of the signature aggregator 20 and the signature verification apparatus is the same as in FIG. 2 (though processing differs depending on a signature scheme).

The configuration illustrated in FIG. 7 may be implemented based on, for example, a multi-signature scheme. The following describes Musig2 (Reference Literature 3), as an example of a multi-signature scheme. It is noted that a signature generation process by a signer in Reference Literature 3 is described here as a signature generation process performed by a distributed signature generation apparatus, which generates a distributed signature by inputting each of the n distributed signing keys.

A pair (xi, Xi)=(xi, g\hat{ }xi) of the distributed signing key xi and verification key Xi (i=1, . . . n) is generated for an i-th signer. It is noted that the distributed key generation apparatus 30 may also be configured, as in the example of Reference Literature 3, such that multiple signers generate the pair of distributed signing keys and verification keys at their respective terminals. In this case, the signer's terminal and the distributed signature generation apparatus 10 may be integrated. However, the pair consisting of the i-th distributed signing key i(xi) corresponding to at least one distributed signature generation apparatus 11 (the i-th distributed signature generation apparatus) and the verification key (pki) may be generated by the distributed key generation apparatus 30, and the i-th distributed signing key i(xi) may be transmitted to the key parameter generation apparatus 50.

### Key Generation:

The key generation function KeyGen performs the following:

Select xi uniformly at random from Zp.

$$x i {←}^{R} Zp \qquad ( 84 )$$

Generate, from xi, a signing key (distributed signing key) ski and Xi (verification key pki) and return the pair of ski and pki.

$$Xi := g \hat{} xi \qquad ( 85 )$$

$$ski := xi , pki := Xi$$

Let L=(X₁, . . . , Xₙ) be a list of verification keys Xi.

A key-aggregate coefficient ai(i=1, . . . , n) for L=(X₁, . . . , Xₙ) is computed with a function KeyAggCoef(L, Xᵢ). KeyAggCoef(L, Xᵢ) may be defined as a hash value H_{agg}(L, Xᵢ) of L and Xᵢ.

$$ai := KeyAggCoef ( L , {X}_{i} ) = {H}_{agg} ( L , {X}_{i} ) \qquad ( 86 )$$

Compute an AggregateKey \tilde{X}.

$$\tilde{X} := {\prod }_{i = 1}^{n} {X}_{i}^{{a}_{i}} \qquad ( 87 )$$

### Signature Generation:

Signature generation includes Round 1 and Round 2.

Round 1 executes the signature functions Sign and SignAgg.

In the signature function Sign, the i-th (i=1, . . . , n) distributed signature generation apparatus #i generates v random values ri,j respectively.

$${r}_{i , j} {←}^{R} {Z}_{p} , j ∈ \{ 1 , … , v \} \qquad ( 88 )$$

The i-th (i=1, . . . , n) distributed signature generation apparatus #i computes a nonce R_{i,j} using r_{i,j}.

$${R}_{i , j} := g \hat{} {r}_{i , j} \qquad ( 89 )$$

The i-th (i=1, . . . , n) distributed signature generation apparatus #i broadcasts a list of v nonces (R_{i, 1}, . . . , R_{i, v}) to each of the other distributed signature generation apparatus 10.

In the Round 2, the signature function Sign′, the signature function SinAgg′, and the signature function Sign″ are executed.

Each i-th (i=1, . . . , n) distributed signature generation apparatus #i may execute the signature functions Sign′, SinAgg′, and Sign “. Alternatively, each i-th (i=1, . . . , n) distributed signature generation apparatus #i may execute the signature function Sign′, while the signature aggregator 20 executes the signature functions SinAgg′ and Sign”.

In the signature function Sign′, when the verification key of the local apparatus is denoted as Xi, let a set of verification keys from other apparatuses, {Xⱼ} (j≠i∈{1, . . . , n}), be provided, and let L={X₁, . . . , Xₙ} denote the set of verification keys involved in the signature (verification keys of apparatuses other than the local apparatus).

In the signature function Sign′, the i-th (i=1, . . . , n) distributed signature generation apparatus #i (signer) uses the key aggregation function KeyAgg to Compute the aggregate verification key X⁻ from the list L=(X₁, . . . , Xₙ) of verification keys.

$$\tilde{X} := KeyAgg ( L ) = {\prod }_{i = 1}^{n} {X}_{i}^{{a}_{i}} \qquad ( 90 )$$

The key aggregation coefficient ai(i=1, . . . , n) is given as follows.

$${a}_{i} := KeyAggCoef ( L , {X}_{i} ) = {H}_{a g g} ( L , {X}_{i} ) \qquad ( 91 )$$

The i-th (i=1, . . . , n) distributed signature generation apparatus #i (signer) receives the output (R₁, . . . , Rᵥ) of the first signature round, computes a hash values of \tilde{X}, (R₁, . . . , Rᵥ), and the message m to set the hash value as a coefficient bj (j=0 to (v−1))

$$bj := {H}_{non} ( j , \tilde{X} , ( {R}_{1} , … , {R}_{v} ) , m ) \qquad ( 92 )$$

and finds a vector (b₀, . . . , bᵥ₋₁) of v coefficients.

The i-th (i=1, . . . , n) distributed signature generation apparatus #i (signer) computes the aggregate nonce R and computes the challenge c used for signing.

$$R := {\prod }_{j = 1}^{v} {R}_{i}^{{b}_{i - 1}} \qquad ( 93 )$$

$$c := Hsig ( \tilde{X} , R , m ) \qquad ( 94 )$$

The i-th (i=1, . . . , n) distributed signature generation apparatus #i (signer) computes the signature si using the challenge c, the key aggregation coefficient aᵢ, the product of the distributed signing key xᵢ, and r_{i,j} to the power of bⱼ₋₁.

$${s}_{i} := c \cdot {a}_{i} \cdot {x}_{i} + {\sum }_{j = 1}^{n} {r}_{i , j}^{{b}_{j - 1}} \qquad ( 95 )$$

outputs R and sᵢ.

The i-th distributed signature generation apparatus #i (signer) broadcasts the distributed signature si to other distributed signature generation apparatuses.

In the signature function SignAgg′, the aggregator (either a distributed signature generation apparatus 10 or a signature aggregator 20) receives the outputs (s₁, . . . , sₙ) from all signers (distributed signature generation apparatus 10) and aggregates them to generate the signature s.

$$s := {\sum }_{i = 1}^{n} {s}_{i} mod p \qquad ( 96 )$$

The signature function Sign″ takes s as input, generates the signature σ:=(R, s), and outputs the signature σ (returns it as a return value). The signature function Sign″ is executed in an aggregator (a distributed signature generation apparatus 10 or a signature aggregator 20).

### Signature Verification:

The signature verification apparatus 40 executes a verification function Ver( [symbol] , m, σ).

The verification function Ver takes as input the aggregate verification key

$$\tilde{X} ( = {\prod }_{i = 1}^{n} {X}_{i}^{{a}_{i}} ) ,$$

message m to be signed, and the signature σ:=(R, s), and checks whether the following holds.

$$g \hat{} s = R ( \tilde{X} ) \hat{} c \qquad ( 97 )$$

If holds, the verification function Ver returns 1 (accepted) as a return value, if not, return 0 (rejected). The verification formula (Equation (97)) is identical to a standard verification formula of a Schnorr signature.

In the verification using Equation (97), when a set of the signature and the message is correct, Equation (97) holds, which is derived as follows.

$$( 98 )$$

$$g \hat{} s = g \hat{} ( {\sum }_{i = 1}^{n} {s}_{i} ) = g \hat{} ( {\sum }_{i = 1}^{n} ( c \cdot ai \cdot xi + {\sum }_{j = 1}^{v} {r}_{i , j}^{{b}_{j - 1}} ) ) = g \hat{} ( {\sum }_{i = 1}^{n} c \cdot ai \cdot xi ) [ g \hat{} ( {\sum }_{i = 1}^{n} ( {\sum }_{j = 1}^{v} {r}_{i , j}^{{b}_{j - 1}} ) ) ] = ( {\prod }_{i = 1}^{n} {X}_{i}^{{a}_{i}} ) \hat{} c [ g \hat{} ( {\sum }_{i = 1}^{n} ( {\sum }_{j = 1}^{v} {r}_{i , j}^{{b}_{j - 1}} ) ) ] = ( \tilde{X} ) \hat{} c {\prod }_{j = 1}^{v} g \hat{} ( {\sum }_{j = 1}^{v} {r}_{i , j}^{{b}_{j - 1}} ) = ( \tilde{X} ) \hat{} c {\prod }_{j = 1}^{v} g \hat{} ( {\sum }_{j = 1}^{v} {r}_{i , j}^{{b}_{j - 1}} ) = ( \tilde{X} ) \hat{} c {\prod }_{j = 1}^{v} {\prod }_{i = 1}^{n} {R}_{i , j}^{{b}_{j - 1}} = ( \tilde{X} ) \hat{} c {\prod }_{j = 1}^{v} {R}_{j}^{{b}_{j - 1}} = ( \tilde{X} ) \hat{} cR$$

In the above derivation,

$${R}_{j} = {\prod }_{i = 1}^{n} {R}_{i , j} \qquad ( 99 )$$

$${R}_{i , j} = g \hat{} {r}_{i , j} \qquad ( 100 )$$

$$and R = {\prod }_{j = 1}^{v} {R}_{j}^{{b}_{j - 1}} \qquad ( 10 )$$

are used.

In FIG. 7, the i-th distributed signature generation apparatus 11 is configured to includes a key-based distributed signature generation apparatus 12 and a biometrics-based distributed signature generation apparatus 13 and receives the key parameter kpi and the verification key Xi to generate a distributed signature si. In computing Equation (95) restated below,

$${s}_{i} := c \cdot {a}_{i} \cdot {x}_{i} + {\sum }_{j = 1}^{n} {r}_{i , j}^{{b}_{j - 1}} \qquad ( 95 )$$

the key-based distributed signature generation apparatus 12 receives and stores the first key parameter kpi(=ENC(xi)+wi) from the key parameter generation apparatus 50. The biometrics-based distributed signature generation apparatus 13 acquires the biometric information wi′, selects Δi uniformly at random from the finite field Fₚ, and generates the key parameter kpi′.

$${kpi}^{′} = ENC ( Δ i ) + {wi}^{′} \qquad ( 102 )$$

The biometrics-based distributed signature generation apparatus 13 transmits the key parameter kpi′ to the key-based distributed signature generation apparatus 12. The key-based distributed signature generation apparatus 12 generates an auxiliary signing key xi′ from the key parameter kpi and the key parameter kpi′. Using a linear code ensures the following holds true.

$${xi}^{′} = DEC ( k p i - {kpi}^{′} ) = DEC \{ ( E N C ( x i ) + w i ) - ( E N C ( Δ i ) + {wi}^{′} ) \} = DE C ( E N C ( x i ) - E N C ( Δ i ) ) + ( w i - {wi}^{′} ) \} = DEC \{ ( E N C ( x i - Δ i ) ) + ( w i - {wi}^{′} ) \} \qquad ( 103 )$$

If the biometric information wi is close to wi′, and the distance d(wi, wi′) is less than or equal to a predetermined threshold th (d(wi, wi′)<=th), then the following holds

$${xi}^{′} = xi - Δ i \qquad ( 104 )$$

It is noted that the signing key xi cannot be extracted by the key-based distributed signature generation apparatus 12 or the biometrics-based distributed signature generation apparatus 13.

The key-based distributed signature generation apparatus 12 generates and transmits a temporary distributed signature sᵢ′ using xᵢ′ (=xᵢ−Δi) to the biometrics-based distributed signature generation apparatus 13. The key-based distributed signature generation apparatus 12 may also transmit c·aᵢ along with the temporary distributed signature sᵢ′ to the biometrics-based distributed signature generation apparatus 13.

$${s}_{i}^{′} := c \cdot {a}_{i} \cdot {x}_{i}^{′} + {\sum }_{j = 1}^{n} {r}_{i , j}^{{b}_{j - 1}} \qquad ( 105 )$$

The biometrics-based distributed signature generation apparatus 13 may compute c·aᵢ·Δᵢ using c·aᵢ and the differential key Δi, and add to the temporary distributed signature sᵢ′ to obtain the distributed signing key sᵢ.

$${s}_{i} := c \cdot {a}_{i} \cdot {Δ}_{i} + {s}_{i}^{′} = c \cdot {a}_{i} \cdot ( {Δ}_{i} + {x}_{i}^{′} ) + {\sum }_{j = 1}^{n} {r}_{i , j}^{{b}_{j - 1}} = c \cdot {a}_{i} \cdot {x}_{i} + {\sum }_{j = 1}^{n} {r}_{i , j}^{{b}_{j - 1}} \qquad ( 106 )$$

In FIG. 7, it is as a matter of course also possible to configure the system such that n number of the i-th distributed signature generation apparatuses 11 are arranged as illustrated in FIG. 4.

There is known a technology called a threshold signature that combines secret sharing with a signature technology. Specifically, it involves distributing a single signing key into multiple shares and applying a signature without ever reconstructing the signing key itself. This means that even if some of the signing key shares are compromised, the signing key itself is kept secure, and a single signature can still be generated.

The configuration illustrated in FIG. 7 may also be implemented based on an m-of-n threshold signature using secret sharing, which can generate a signature from m out of n distributed signatures without revealing an aggregated distributed signing key.

As is well known, Shamir's secret sharing scheme constructs a polynomial of degree (t−1) such that f(0)=secret, with a threshold t, and distributes shares (i, f(i)). Once t shares are collected, the polynomial f(x) can be reconstructed to find the constant term f(0) (secret). Lagrange interpolation, as illustrated in Equation (107), may be used to reconstruct the polynomial f(x).

$$f ( x ) := {\sum }_{j = 1}^{t} f ( t ) {\prod }_{i \neq j} \frac{x - x i}{x j - x i} \qquad ( 107 )$$

To find the secret for f(0) from the restored f(x), compute the following:

$$f ( 0 ) := {\sum }_{i = 1}^{t} f ( i ) {λ}_{i} \qquad ( 108 )$$

where, λᵢ is given by the following (Lagrange multiplier).

$${λ}_{i} = {\prod }_{j = 1 ( \neq i )}^{t} \frac{j}{j - 1} \qquad ( 109 )$$

An overview based on the example of FROST (Flexible Round-Optimized Schnorr Threshold Signatures) is provided (reference may be made to Reference Literature 4, etc., for details). The following is based on Reference Literature 4.

FROST's Distributed Key Generation (DKG) is performed using, for example, Pedersen's Verifiable Secret Sharing (VSS) scheme for DKG. Each participant Pi (i=1, . . . , n) is assumed to have a unique identification number ranging from 1 to n. Each participant Pi performs the following.

### Distributed Key Generation:

Each participant Pi generates t (aᵢ₀, . . . , aᵢ₍ₜ₋₁₎)←^{R}Z_{q} and constructs a t−1 th degree polynomial f(x).

$${f}_{i} ( x ) = {\sum }_{i = 0}^{t - 1} {a}_{ij} {x}^{j} = {a}_{i ( t - 1 )} {x}^{t - 1} + {a}_{i ( t - 2 )} {x}^{t - 2} + … + {a}_{0} \qquad ( 110 )$$

Each participant Pi generates a Schnorr signature σᵢ:=(Rᵢ, μᵢ) to prove knowledge of aᵢ₀.

$${μ}_{i} := k + {a}_{i 0} \cdot {c}_{i} \qquad ( 111 )$$

$${c}_{i} = H ( i , Φ , g \hat{} {a}_{i 0} , {R}_{i} ) \qquad ( 112 )$$

Here, Φ is a context string used to prevent replay attacks.

Each participant Pi computes a public commitment

$${\vec{C}}_{i} = < {ϕ}_{i 0} , … , {ϕ}_{i} ( t - 1 ) > , \qquad ( 113 )$$

$$Where$$

$${ϕ}_{ij} = g \hat{} {a}_{ij} , 0 \leq j \leq t - 1 , \qquad ( 114 )$$

and broadcasts \vec{C}i and σᵢ to all other participants.

From the \vec{C}₁ and σ₁ (1≠i) received from other participants, verify whether the signature

σ₁:=(R₁,μ₁) (115)

satisfies (i.e., whether the signature is valid for φᵢ₀),

$${R}_{1} = g \hat{} {μ}_{1} \cdot {ϕ}_{i 0} \hat{} ( {\vec{C}}_{1} ) \qquad ( 116 )$$

$$( where c 1 = H ( 1 , Φ , {ϕ}_{10} , {R}_{1} ) , \qquad ( 117 )$$

and concludes Round 1.

In Round 2, each participant Pi sends a share (i, f(i)) to other participants, where i is the ID of the other participant. Each participant who receives shares verifies whether the shares were correctly computed using the list of public keys received in Round 1.

Each participant receives shares from all other participants, then aggregates these shares to derive the aggregated share for the aggregate key (aggregate signing key). The share (long-lived private signing share) for participant Pi with ID i is given by the following Equation (118).

$${s}_{i} := {f}_{1} ( i ) + {f}_{2} ( i ) + … + {f}_{n} ( i ) \qquad ( 118 )$$

In the Round 1, each participant Pi holds a share (si) of the combined polynomial generated randomly by all participants. Each participant Pi computes their respective public key (verification key) Yi.

$${Y}_{i} = g \hat{} {s}_{i} \qquad ( 119 )$$

Each participant Pi computes the group's public key (verification key) Y.

$$Y := {\prod }_{j = 1}^{n} {ϕ}_{j 0} \qquad ( 120 )$$

Y becomes an aggregated public key (this concludes Round 2).

### Signature Generation:

As a preprocessing round, each participant Pi generates a pair of secret nonces and a corresponding public commitment share (where j is a counter).

$$< ( ( ( dij , Dij = g \hat{} dij ) ( eij , Eij = g \hat{} eij ) ) > \qquad ( 121 )$$

Each participant Pi discloses a list of π pairs (i, Li) to the other participants.

$$Li := < ( Dij , Eij > \qquad ( 122 )$$

Since each signature process uses one pair of this nonce value, once n pairs have been exhausted, this preprocessing round is executed again.

Once the DKG determines the aggregate public key and the preprocessing round concludes, the signature round proceeds.

One of the signers becomes the signature aggregator (SA). The signature aggregator SA selects α (t≤α≤n). Including oneself, α people become participants. The signature aggregator SA selects an available commitment (Di, Ei) (i∈S, where S is the set of α participants).

The resulting secret nonce is

$$k := {\sum }_{i ∈ S} {k}_{i} \qquad ( 123 )$$

where Σ_{i∈S} denotes the sum over all i∈S.

$$ki := di + ei \cdot ρ i \qquad ( 124 )$$

(di, ei) corresponds to (Di=g\hat{ }di, Ei=g\hat{ }ei).

Next, the signature aggregator SA generates set B and sends (m, B) to all the participants Pi (i∈S).

Here, B is an ordered list of triples <((i, Di, Ei)><i∈S>.

After receiving (m, B) from the signature aggregator SA to initialize the signature operation, participants Pi (i∈S) verify that m is the message to be signed. Next, using m and B, all the participants Pi (i∈S) derive “combined value” pi (i∈S) such that

$$ρ i := {H}_{1} ( i , m , B ) \qquad ( 125 )$$

holds.

Here, H₁ is a hash function, and its output belongs to Z*q.

Next, each participant Pi (i∈S) determines a commitment Ri of each participant within S.

$$Ri := Di \cdot ( Ei ) \hat{} ρ i \qquad ( 126 )$$

This allows to associate the message, the set of signers, and each participant's commitment with each share of the signatures.

Each participant, using each commitment Ri of each participant within S, computes a commitment R to a set of signers.

$$R := \prod < i ∈ S > Ri \qquad ( 127 )$$

Similar to Single-party Schnorr signatures, each participant computes a challenge.

$$c := {H}_{2} ( R , Y , m ) \qquad ( 128 )$$

A response of each participant for the challenge c may be set as follows.

$${z}_{i} := {d}_{i} + ( {e}_{i} \cdot {ρ}_{i} ) + {λ}_{i} \cdot {s}_{i} \cdot c \qquad ( 129 )$$

where si is the long-lived private signing share of the signing key in Equation (117).

The signature aggregator SA finally checks consistency of Zi reported by each participant, along with the commitment shares (Di, Ei) and the public key (verification key) share Yi. If all participants output the correct zi, a group response becomes a sum of zi for participants Pi (i∈S).

$$z := {\sum }_{i ∈ S} z i \qquad ( 130 )$$

A signature of the group for the message mis given as follows.

$$σ := ( R , z ) \qquad ( 131 )$$

This signature can be verified by anyone using a standard Schnorr verification using Y as the public key (verification key).

The key parameter generation apparatus 50 may receive the long-lived private signing share si (Equation (118)) of the participant Pi, generate a key parameter kpi, and transmit the key parameter kpi to the distributed signature generation apparatus 11 corresponding to the participant Pi. The key parameter generation apparatus 50 generates a key parameter kpi(=ENC(si)+wi) using biometric information wi of the participant i and sends the key parameter to the distributed signature generation apparatus 11 for registration. In the signature computation of Equation (120), the biometrics-based distributed signature generation apparatus 13 of the distributed signature generation apparatus 11 generates the key parameter kpi′ using the biometric information wi′ and the differential key Δi, and sends it to the key-based distributed signature generation apparatus 12.

The key-based distributed signature generation apparatus 12 decrypts a difference between the key parameters kpi and kpi′ (DEC(kpi−kpi′)) to obtain a one-time signature key si′(=sᵢ−Δi), generates a temporary signature zi′,

$${z}_{i}^{′} := di + ( ei \cdot ρ i ) + λ i \cdot {si}^{′} \cdot c \qquad ( 132 )$$

and transmits the temporary signature zi′, λi, and challenge c to the biometrics-based distributed signature generation apparatus 13.

The biometrics-based distributed signature generation apparatus 13 may compute λi·Δi·c, using Δi, and then generate the distributed signature zi, based on

$${z}_{i} := {λ}_{i} \cdot {Δ}_{i} \cdot c + {z}_{i}^{′} = {d}_{ij} + ( {e}_{ij} \cdot {ρ}_{i} ) + {λ}_{i} \cdot ( {Δ}_{i} + {s}_{i}^{′} ) \cdot c = {λ}_{i} \cdot {Δ}_{i} \cdot c + {z}_{i}^{′} = {d}_{ij} + ( {e}_{ij} \cdot {ρ}_{i} ) + {λ}_{i} \cdot {s}_{i}^{′} \cdot c . \qquad ( 133 )$$

In the distributed signature generation apparatus 11 corresponding to participant Pi, the share si (long-lived private signing share) of the participant Pi is not revealed. In this case, although depending on the implementation form, in FIG. 7, the key parameter generation apparatus 50 may be configured to be placed between a terminal of the participant Pi constituting the distributed key generation apparatus 30 and the distributed signature generation apparatus 11 corresponding to the participant Pi.

It is noted that that while the above embodiments/examples were described in accordance with a signature scheme possessing key homomorphism, the present disclosure may be equally applicable to signature schemes lacking key homomorphism, such as ECDSA (Elliptic Curve Digital Signature Algorithm) and EdDSA (Edwards-curve Digital Signature Algorithm). ECDSA can be outlined as follows.

### Key Generation:

$$Secret key : x {←}^{R} {Z}_{n}^{*} \qquad ( 134 )$$

$$( {Z}_{n}^{*} = [ 1 , r - 1 ] , n : prime number ) \qquad ( 135 )$$

x←^{R} X denotes choosing an element x uniformly at random from a finite set X.

$$Public Key : P := xG \qquad ( 136 )$$

(G: base point of an elliptic curve and generator of order n.)
P=xG corresponds to an operation where the base point G is added x times (G+ . . . +G).

### Signature Generation:

1. Generate a random number k uniformly at random.

$$k {←}^{R} {Z}_{n}^{*} \qquad ( 137 )$$

2. Compute

$$R := k G . \qquad ( 138 )$$

R=(x1, y1) is a rational point on the elliptic curve (an integer point is a rational point).
3. Compute

$$r := xR mod n . \qquad ( 139 )$$

(xR represents an integer part of x1 of the rational point R)
If r=0, return to step 1.
4. Compute a hash value H(m) of message m.
5. Compute

$$s := k \hat{} ( - 1 ) ( H ( m ) + {r}^{*} x ) mod n . \qquad ( 140 )$$

(\hat{ } is an exponentiation operator)
6. Output a signature σ=(r, s).

### Signature Verification:

1. Receive the signature σ=(r, s) and the message m.
2. Compute a hash value H(m).
3. Compute

$$u 1 := H ( m ) s \hat{} ( - 1 ) mod n , \qquad ( 141 a )$$

$$u 2 := rs \hat{} ( - 1 ) mod n . \qquad ( 141 b )$$

4. Compute

$${R}^{′} = ( x {1}^{′} , y {1}^{′} ) = u 1 G + u2Q . \qquad ( 142 )$$

(Q=xG: Public Key (Verification Key))
5. Compute

$${r}^{′} = {xR}^{′} mod n \qquad ( 143 )$$

where xR′ is an integer representation of x1′ of the rational point R′.
6. If r′=r, output 1 (accepted); if r′≠r, output 0 (rejected).

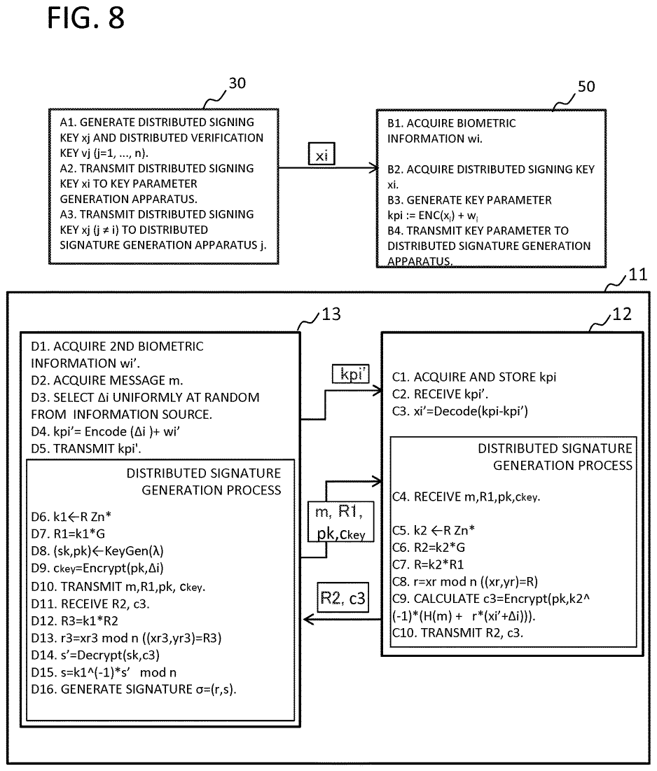

FIG. 8 schematically illustrates a computational flow for two-party ECDSA signature generation between the biometrics-based distributed signature generation apparatus 13 and the key-based distributed signature generation apparatus 12.

The distributed key generation apparatus 30 selects a distributed signing key xj uniformly at random from an information source and generates a distributed verification key vj (j=(1, . . . , n)) corresponding to the distributed signing key xj (j=(1, . . . , n) (Step A1).

$${x}_{j} {←}^{R} {Z}_{n}^{*} \qquad ( 144 )$$

$${v}_{j} := {x}_{j} G \qquad ( 145 )$$

where G is a base point of the elliptic curve.

The distributed key generation apparatus 30 transmits the distributed signing key xi to the key parameter generation apparatus 50 (Step A2), and transmits the distributed signing key xj (where j≠i) to the distributed signature generation apparatus j (Step A3).

The key parameter generation apparatus 50 acquires biometric information wi (first biometric information) of an i-th signer i (Step B1). The key parameter generation apparatus 50 receives the distributed signing key xi transmitted from the distributed key generation apparatus 30 (Step B2). The key parameter generation apparatus 50 generates a first key parameter kpi using a value obtained by encoding the distributed signing key xi with an error-correcting encoding function ENC and the biometric information wi of the i-th signer (Step B3).

$$kpi := ENC ( x i ) + w i \qquad ( 146 )$$

The key parameter generation apparatus 50 transmits the first key parameter kpi to the distributed signature generation apparatus 11 (Step B4).

The key-based distributed signature generation apparatus 12 of the distributed signature generation apparatus 11 acquires and stores the first key parameter kpi (Step C1).

The biometrics-based distributed signature generation apparatus 13 of the distributed signature generation apparatus 11 acquires biometric information wi′ (second biometric information) (Step D1). The biometrics-based distributed signature generation apparatus 13 acquires a message m to be signed (Step D2). The biometrics-based distributed signature generation apparatus 13 generates a differential key Δi uniformly at random from an information source (Step D3).

$$Δ i {←}^{R} {Z}_{n}^{*} \qquad ( 147 )$$

The biometrics-based distributed signature generation apparatus 13 generates a second key parameter kpi′ using the differential key Δi and the biometric information wi′ (Step D4).

$${kpi}^{′} := ENC ( Δ i ) + {wi}^{′} \qquad ( 148 )$$

The biometrics-based distributed signature generation apparatus 13 transmits the second key parameter kpi′ to the key-based distributed signature generation apparatus 12 (Step D5).

Upon reception of the second key parameter kpi′ (Step C2), the key-based distributed signature generation apparatus 12 decodes a difference between the first key parameter kpi and the second key parameter kpi′ to obtain a temporary (one-time) signing key xi′ (Step C3).

$$\begin{matrix}{wi}^{′} = DEC ( k p i - {kpi}^{′} ) \\ = DEC \{ ( E N C ( s i ) + w i ) - ( E N C ( Δ i ) + {wi}^{′} ) \} \\ = DEC \{ EN C ( s i - Δ i ) + ( w i - {wi}^{′} ) \}\end{matrix} \qquad ( 149 )$$

When the biometric information wi is close to wi′, that is, when the distance d(wi, wi′) is less than or equal to a predetermined threshold th (d(wi, wi′)≤th), from Equation (149) the following holds.

$${xi}^{′} = xi - Δ i \qquad ( 150 )$$

In the biometrics-based distributed signature generation apparatus 13, the following steps are performed according to a two-party distributed signature generation process.
1. Select the first random number k1 uniformly at random (Step D6).

$$k 1 {←}^{R} {Z}_{n}^{*} \qquad ( 151 )$$

(k1∈[1, n−1])
2. Compute the rational point R1 on the elliptic curve (Step D7).

$$R 1 := k 1 * G \qquad ( 152 )$$

3. Generate a secret key (one-time secret key) sk and a public key (one-time public key) pk, using a specified key generation algorithm (sk, pk←Key Gen(λ)), where λ is a key length (Step D8).
4. Encrypt the differential key Δi using the public key (temporary public key) pk (Step D9).

$${c}_{key} := Encrypt ( pk , Δ i ) \qquad ( 153 )$$

As an encryption scheme, the Paillier encryption or similar scheme possessing additive homomorphism may be used.
5. Transmit the key c_{key} which is an encrypted key of differential key Δi, the message m, R1, and the public key pk to the key-based distributed signature generation apparatus 12 (Step D10).

The key-based distributed signature generation apparatus 12 receives the key c_{key}, which is the encrypted key of the differential key Δi, the message m, R1, and the public key pk from the biometrics-based distributed signature generation apparatus 13 (Step C4).

The key-based distributed signature generation apparatus 12 selects a second random number k2 uniformly at random (Step C5).

$$k 2 {←}^{R} Z {n}^{*} \qquad ( 154 )$$

(k2∈[1,n−1]))

The key-based distributed signature generation apparatus 12 computes a rational point R2 on the elliptic curve using the second random number k2 (Step C6).

$$R 2 := k 2 * G \qquad ( 155 )$$

The key-based distributed signature generation apparatus 12 computes

R:=k2*R1=(x1,y1) (156)

using the second random number k2 and R1 received from the biometrics-based distributed signature generation apparatus 13 (Step C7).

The key-based distributed signature generation apparatus 12 computes

$$r := xr mod n \qquad ( 157 )$$

(Step C8), where xr is an integer representation of x1 of the rational point R in Equation (156).

The key-based distributed signature generation apparatus 12 computes a hash value H(m) of the message m, computes c3 while keeping the encrypted differential

$$key Δ i encrypted ( c ) ( Step C 9 ) . \qquad ( 158 )$$

$$c 3 := Encrypt ( pk , k 2 \hat{} ( - 1 ) * ( H ( m ) + r * ( {xi}^{′} + Δ i ) ) )$$

To determine c3 in Equation (158), the key-based distributed signature generation apparatus 12 computes an inverse element k2\hat{ }(−1) of the second random number k2 over Zn*(k2\hat{ }(−1)∈Zn*), then computes a value (k2\hat{ }(−1))H(m) mod n by multiplying k2\hat{ }(−1) by the hash value H(m) of the message m, and further computes a value (k2\hat{ }(−1))r*x′ mod n, which is obtained by multiplying a value r*x′ (where r is multiplied by the temporary (one-time) signing key x′) by (k₂\hat{ }(−1)) to obtain a sum thereof:

$$( k 2 \hat{} ( - 1 ) ) \{ H ( M ) + r * {x}^{′} \} mod n \qquad ( 159 )$$

The key-based distributed signature generation apparatus 12 encrypts the sum using the public key pk.

$$c 1 := Encrypt ( pk , k 2 \hat{} ( - 1 ) * \{ ( H ( M ) ) + r * {x}^{′} \} mod n ) \qquad ( 160 )$$

The key-based distributed signature generation apparatus 12 performs scalar multiplication on (k2\hat{ }(−1))*r mod n for c_{key}=Encrypt(pk, Δ) received from the biometrics-based distributed signature generation apparatus 13, and obtains

$$c 2 := Encrypt ( pk , ( k 2 \hat{} ( - 1 ) ) * r * Δ ) mod n ) . \qquad ( 161 )$$

The key-based distributed signature generation apparatus 12 obtains

$$( 162 )$$

$$\begin{matrix}c 3 := c 1 + c 2 \\ = Encrypt ( pk , k 2 \hat{} ( - 1 ) * ( H ( M ) + r * {x}^{′} ) ) + Encrypt ( pk , k 2 \hat{} ( - 1 ) * r * Δ ) \\ = Encrypt ( pk , k 2 \hat{} ( - 1 ) * ( H ( M ) + r * ( {x}^{′} + Δ ) mod n )\end{matrix}$$

for c1 and c2 by additive homomorphism.

The key-based distributed signature generation apparatus 12 transmits R2 (R2=k2*G) and the cryptographic value c3 to the biometrics-based distributed signature generation apparatus 13 (Step C10).

The biometrics-based distributed signature generation apparatus 13 receives R2 and c3 from the key-based distributed signature generation apparatus 12 (Step D11).

Upon reception of R2 and c3, the biometrics-based distributed signature generation apparatus 13 performs the following:

The biometrics-based distributed signature generation apparatus 13 computes a rational point R3 on the elliptic curve from the first random number k1 and R2 (Step D12).

$$R 3 := k 1 * R 2 = ( x 3 , y 3 ) \qquad ( 163 )$$

The biometrics-based distributed signature generation apparatus 13 computes

$$r 3 := xr 3 mod n \qquad ( 164 )$$

where xr3 is an integer representation of x3 of the rational point R3=(x3, y3) on the elliptic curve.) (Step D13).

The biometrics-based distributed signature generation apparatus 13 decrypts the ciphertext c3 using a private key sk (Step D14).

$${s}^{′} := Decrypt ( sk , c 3 ) \qquad ( 165 )$$

The biometrics-based distributed signature generation apparatus 13 computes, using an inverse (inverse element) of the first random number k1==k1\hat{ }(−1) and s′ (Step D15).

$$s := k 1 \hat{} ( - 1 ) * {s}^{′} mod n = ( k 1 * k 2 ) \hat{} ( - 1 ) * ( H ( M ) + r * ( {x}^{′} + Δ ) mod n \qquad ( 166 )$$

The biometrics-based distributed signature generation apparatus 13 generates a signature σ=(r, s), where r is r3 computed using Equation (164), and s is computed using Equation (166) (Step D16). Signature verification is performed by receiving the message m and the signature σ and verifying the signature σ for the message m using the verification key vi(=xiG) corresponding to the signing key xi (1/0←Verify (vi, σ, m)). That is, a hash value H(m) of the message m is computed, and then

$$u 1 := H ( m ) s \hat{} ( - 1 ) mod n , \qquad ( 167 a )$$

$$u 2 := rs \hat{} ( - 1 ) mod n \qquad ( 167 b )$$

$$are computed .$$

$${R}^{′} := ( x {1}^{′} , y {1}^{′} ) = u 1 G + u 2 vi \qquad ( 168 )$$

where vi=xiG is the verification key corresponding to the signing key xi.

Substituting u1 and u2 of Equations (167a) and (167b) into the right-hand side of Equation (168) becomes

$$( 169 )$$

$$\begin{matrix}{R}^{′} = ( H ( m ) s \hat{} ( - 1 ) mod n ) G + ( rs \hat{} ( - 1 ) mod n ) xiG \\ = s \hat{} ( - 1 ) ( H ( m ) + r * xi mod n ) G \\ = [ ( k 1 * k 2 ) * ( H ( m ) + r * ( {xi}^{′} + Δ i ) mod n ) ] \hat{} ( - 1 ) ( H ( M ) + r * xi mod n ) G\end{matrix}$$

In Equation (169), if

$$xi = {xi}^{′} + Δ i mod n , \qquad ( 170 )$$

a denominator (H(M)+r*(xi′+Δi) mod n) in Equation (169) matches a numerator (H(M)+r*xi mod n), and thus the following holds.

$${R}^{′} = ( k 1 * k 2 ) G = R 3 ( = ( x 3 , y 3 ) ) \qquad ( 171 )$$

If xR′ and xr3 are each integer representation of x1′ in Equation (168) and x3 in Equation (171), respectively, then the following holds.

$${r}^{′} = {xR}^{′} mod n = xr 3 mod n ( = r 3 ) \qquad ( 172 )$$

In this case, r′ matches the r(=r3) of the signature (r, s), and the verification function Verify (vi, σ, m) returns acceptance (1).

On the other hand, in Equation (170), if

$$xi \neq {xi}^{′} + Δ i mod n \qquad ( 173 )$$

holds, then the denominator (H(m)+r*(xi′+Δi) mod n) in Equation (169) does not match the numerator (H(m)+

$$r * xi mod n ) , resulting in {R}^{′} \neq ( k 1 * k 2 ) G , \qquad ( 174 )$$

therefore, R′≠R3, then
r′=xR′ mod n≠xr3 mod n(=r3).

Since r′ does not match the r(=r3) of the signature (r, s), the verification function Verify (v, σ, m) returns a rejection (0).

The above described application of the biometrics-based distributed signature generation protocol to a signature scheme(s) lacking key homomorphism, such as ECDSA, is feasible not only for a threshold signature scheme using secret sharing method like FROST but also for the aggregate signature, sequential aggregate signature, and multi-signature.

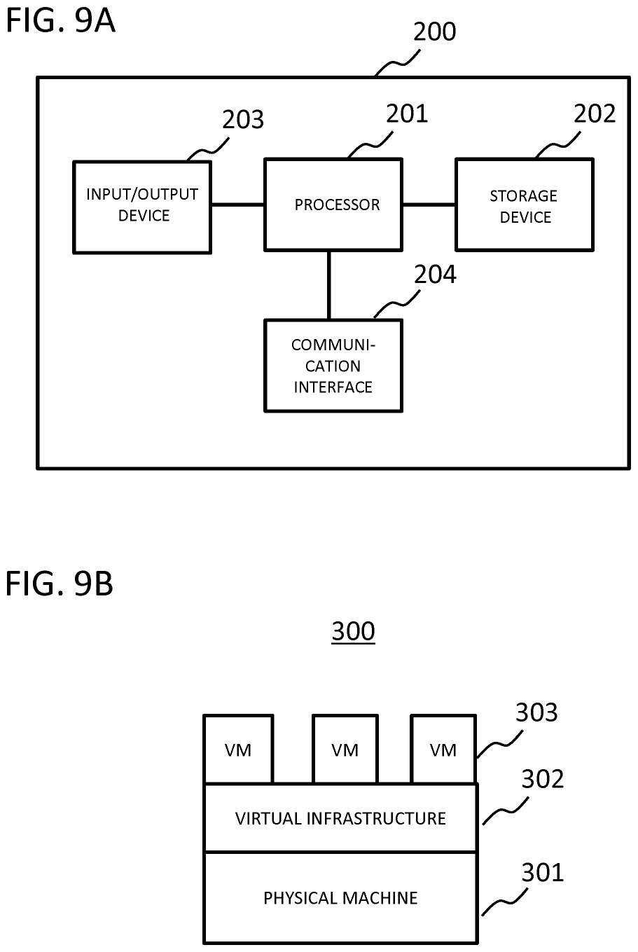

FIGS. 9A and 9B are schematic diagrams each illustrating an example where the apparatuses of the aforementioned system 100 are implemented by computers equipped with communication functions and capable of communicating with each other via a network(s). Referring to FIG. 9A, the apparatuses (10, 11 (12, 13), 20, 30, 40, 50) of FIG. 2 may be configured to include a processor 201 (which may be plural), a storage device 202, a n input/output device 203, and a communication interface 204. The storage device 202 may be configured to include semiconductor storage such as RAM (Random Access Memory), ROM (Read-Only Memory), or EEPROM (Electrically Erasable and Programmable ROM), as well as HDD (Hard Disk Drive), CD (Compact Disc), DVD (Digital Versatile Disc), etc. The processor 201 executes a program (not illustrated) stored in the storage device 202 to implement the processing and functions of each device. The input/output device 203 may be configured to include a keyboard and display. In the key parameter generation apparatus 50 and the biometrics-based distributed signature generation apparatus 13 of FIG. 2, the input/output device 203 may be configured to include a sensor(s) for acquiring biometric information. In this case, the sensor may be an image sensor (camera) when the biometric information is a face, iris, etc. For fingerprints, the sensor may be a fingerprint sensor, for finger (palm) veins, the sensor may be, for example, an LED (Light Emitting Diode) that emits near-infrared light and a near-infrared camera that captures light transmitted through finger (palm). The sensor may be a removable sensor, such as a USB a (Universal Serial Bus) device. The communication interface 204 may be configured to include a network interface(s) card or transceiver(s), enabling communication connections via LAN (Local Area Network), WAN (Wide Area Network) such a s the Internet, wireless LAN, mobile communication networks, etc. Additionally, the communication interface 204 may be configured to a n external sensor(s) (e.g., communicate with Bluetooth®-connected sensor(s)) and receive biometric information acquired by the external sensors.

FIG. 9B is a schematic diagram illustrating an example where the apparatuses 10, 11, 20, etc., of the signature system 100 described above are implemented as virtual machines using server virtualization technology. Multiple virtual machines VM 303 operate on a virtual infrastructure 302, such as a hypervisor, implemented on a physical machine 301. One or more of the apparatuses 10, 11, 20 of the signature system 100 may be implemented as virtual machines VM 303. Although physically a single server, a virtual server environment is provided where multiple servers operate. Each virtual machine (VM) is preferably configured to run in an isolated environment within memory space. In this case, within the virtual machine (VM), a program that implements the processing of any one of apparatuses 10, 11, or 20 runs on the virtual machine's virtual operating system (OS). The virtual machine VM 303, which virtually implements one of the apparatuses, may be configured to communicate with other virtual machines via a virtual network, or it may be configured to communicate with other apparatuses via a LAN, Internet, or other WAN through the physical interface (communication interface) of the physical machine 301. In this case, the multiple virtual machines VM 303 need not run on the same physical machine; they may also be configured to communicate with virtual machines VM running on other physical machines.

### REFERENCE LITERATURE

[Reference Literature 1] Dan Boneh, Manu Drijvers, and Gregory Neven, “BLS Multi-Signatures With Public-Key Aggregation”, Mar. 24, 2018, Stanford University
[Reference Literature 2] Yanbo Chen, Yunlei Zhao, “Half-Aggregation of Schnorr Signatures with Tight Reductions”, Computer Security-ESORICS 2022 pp. 385-404
[Reference Literature 3] Chelsea Komlo, Ian Goldberg, “FROST: Flexible Round-Optimized Schnorr Threshold Signatures”, Selected Areas in Cryptography. SAC 2020. Lecture Notes in Computer Science, vol 12804. Springer-Verlag, 1 Oct. 2020
[Reference Literature 4] Jonas Nick, Tim Ruffing, Yannick Seurin, “MuSig2: Simple Two-Round Schnorr Multi-Signatures”, Advances in Cryptology-CRYPTO 2021 August, 2021, pp. 189-221,
[Reference Literature 5] Haruna Higo, Toshiyuki Isshiki, Saki Otsuki, Kenji Yasunaga, “Fuzzy Signature with Biometric-Independent Verification”, 2023 International Conference of the Biometrics Special Interest Group (BIOSIG), IEEE, 20-22 Sep. 2023
[Reference Literature 6] Derler, David/Slamanig, Daniel. “Key-homomorphic signatures: definitions and applications to multiparty signatures and non-interactive zero-knowledge.” Designs, Codes and Cryptography, Vol. 87.
[Reference Literature 7] JP2021-087167A

The above embodiments and examples are provided as examples, including but not limited to the following.
(Note 1) A signature system includes a plurality of first apparatuses, each generating a distributed signature, wherein at least one of the first apparatuses is configured to receive a first parameter generated using a distributed signing key corresponding to the at least one of the first apparatuses and first biometric information, and generate the distributed signature, using second biometric information and the first parameter.
(Note 2) The signature system according to Note 1 further includes:
a second apparatus configured to perform processing to generate a plurality of distributed signing keys corresponding to each of the plurality of first apparatuses; a third apparatus configured to perform processing to generate the first parameter from a pair of the distributed signing key corresponding to the at least one of the first apparatuses and the first biometric information; and a fourth apparatus configured to perform verification on a single signature into which the plurality of the distributed signatures are aggregated.
(Note 3) The signature system according to Note 1 or 2 includes a fifth apparatus configured to perform processing to receive the plurality of distributed signatures each generated by the plurality of first apparatuses using the plurality of distributed signing keys for messages to be signed, and generate the single signature into which the plurality of the distributed signatures are aggregated.
(Note 4) In the signature system according to any one of Notes 1 to 3, the k-th (k=2, . . . , n−1) first apparatus among n number (where n is an integer greater than or equal to 2) of the first apparatuses includes at least a processor configured to perform processing to:
receive (k−1)th distributed signature generated by (k−1)th first apparatus,
generate k-th distributed signature based on the distributed signature generated using k-th distributed signing key and the (k−1)th distributed signature,
transmit the k-th distributed signature to (k+1)th first apparatus, and
output n-th distributed signature generated by n-th first apparatus as a single aggregate signature.
(Note 5) In the signature system according to any one of Notes 1 to 4, each of the n number (where n is an integer greater than or equal to 2) of the first apparatuses (i=1, . . . , n) is configured to perform processing to: transmit a list of nonces (Ri, 1, . . . . Ri, v) each generated from random values (ri,j) (j=1, . . . , v) to the other first apparatuses, compute a key aggregation coefficient from a list (L) of verification keys for the plurality of first apparatuses, and generate an aggregate verification key (X^{~}) from the key aggregation coefficient and the verification key, compute the aggregated value (Rj=Π<i=1, v>Ri,j) of the list of nonces for each of said plurality of first apparatuses, compute a coefficient (b₁, . . . , b v) from the aggregate verification key (\tilde{X}), (Ri,1, . . . . Ri, v), and the message to be signed, compute a nonce (RΠ<i=1,v>Rj\hat{ }(bj−1)) used for the signature, using the aggregated value (Rj) of the nonce and the coefficient, compute a challenge (c) used for the signature from the aggregate verification key (\tilde{X}), the signature nonce (R), and the message,
generate a distributed signature si from the challenge (c), the product of the key aggregation coefficient and the distributed signing key, and the result of operations involving the random value (ri, j) and the coefficient (bj) for j=1, . . . , v.
(Note 6) In the signature system according to any one of Notes 1 to 3, said at least one of the first apparatuses uses a share of the signing key as the distributed signing key, receives the first parameter generated using the distributed signing key and the first biometric information, and generates a distributed signature using the second biometric information and the first parameter.
(Note 7) In the signature system according to any one of Notes 1 to 3, the plurality of first apparatuses are configured to perform processing to generate the distributed signature according to a predetermined signature scheme selected from aggregate signature, sequential aggregate signature, multi-signature, and threshold signature.
(Note 8) In the signature system according to any one of Notes 1 to 7, said at least one of the first apparatuses includes a first unit and a second unit to communicate with each other, wherein the first unit is configured to perform processing to receive the first parameter, and the second unit is configured to perform processing to acquire the second biometric information.
(Note 9) In the signature system according to Note 8, the second unit is configured to perform processing to generate a differential key, generate a second parameter using the first biometric information and the differential key, and transmit the second parameter to the first unit;
and the first unit is configured to perform processing to generate a temporary distributed signing key using the first parameter and the second parameter, generate a temporary distributed signature for a message to be signed using the temporary distributed signing key, and transmit the temporary distributed signature to the second unit; and
the second unit is configured to perform processing to generate the distributed signature corresponding to the at least one of the first apparatuses using the temporary distributed signature received from the first unit and the differential key.
(Note 10) In the signature system according to any one of Notes 1 to 9, said at least one of the first apparatuses includes: a first unit that receives the first parameter, and a second unit that acquires second biometric information, generates a differential key, generates a second parameter using the first biometric information and the differential key, and transmits the second parameter to the first unit; and the first unit is configured to perform processing to generate a temporary distributed signing key using the first parameter and the second parameter, generate a temporary distributed signature for a message to be signed using the temporary distributed signing key and transmit the temporary distributed signature to the second unit, and the second unit is configured to perform processing to generate the distributed signature corresponding to the at least one of the first apparatuses using the temporary distributed signature received from the first unit and the differential key.
(Note 11) A signature method in which each of a plurality of distributed signature generation parts generate a distributed signature, the method comprising,
   by at least one of the plurality of distributed signature generation parts:
   receiving a first parameter generated using a distributed signing key corresponding to the at least one distributed signature generation part and first biometric information; and
   generating the distributed signature using second biometric information and the first parameter.
(Note 12) In the signature method according to Note 11, a key generation part generates a plurality of the distributed signing keys,
a parameter generation part generates the first parameter from a pair of the distributed signing key corresponding to the at least one distributed signature generation part and the first biometric information, and a signature verification part performs verification on a single signature into which the plurality of distributed signatures are aggregated.
(Note 13) In the signature method according to Note 11 or 12, a signature aggregation part receives the plurality of distributed signatures generated using the plurality of distributed signing keys and generates the single aggregate signature.
(Note 14) In the signature method according to Note 11 or 12, k-th (k=2, . . . , n−1) distributed signature generation part among n number (where n is an integer greater than or equal to 2) of the distributed signature generation parts receives (k−1)th distributed signature generated by (k−1)th distributed signature generation part, generates k-th distributed signature by updating the (k−1)th distributed signature using a distributed signature generated with k-th distributed signing key,
transmits the k-th distributed signature to (k+1)th distributed signature generation part, and outputs n-th distributed signature generated by n-th distributed signature generation part as a single aggregate signature.
(Note 15) In the signature method according to Note 11 or 12, the plurality of distributed signature generation parts generate the distributed signature according to one of predetermined signature schemes: aggregate signature, sequential aggregate signature, multi-signature, or threshold signature.
(Note 16) In the signature method according to Note 15, said at least one of the distributed signature generation parts uses a share of the signing key as the distributed signing key, receives the first parameter generated using the distributed signing key and the first biometric information, and generates a distributed signature using the second biometric information and the first parameter.
(Note 17) In the signature method according to any one of Notes 11 to 16, in said at least one of the distributed signature generation parts, a first unit receives the first parameter, and a second unit acquires the second biometric information.
(Note 18) In the signature method according to Note 17, the second unit generates a differential key, generates a second parameter using the first biometric information and the differential key, and transmits the second parameter to the first unit; and the first unit generates a temporary distributed signing key using the first parameter and the second parameter, generates a temporary distributed signature for a message to be signed using the temporary distributed signing key, and transmits the temporary distributed signature to the second unit; and
the second unit generates the distributed signature using the temporary distributed signature received from the first unit and the differential key.
(Note 19) A non-transitory computer readable medium storing a program to cause a processor of at least one of a plurality of first apparatuses, each generating a distributed signature, to execute process processing comprising: receiving a first parameter generated using a distributed signing key corresponding to the at least one of the plurality of first apparatuses and first biometric information, and generating the distributed signature using second biometric information and the first parameter.

The disclosures of each of the Patent Literature and Reference Literatures are hereby incorporated by reference into this document. Within the scope of the disclosure of the present application (including the claims), modifications, adjustments, and combinations of embodiments or examples based on the fundamental technical concept are possible. Furthermore, within the scope of the claims of the present disclosure, various combinations or selections of the disclosed elements (including each element of the appended claims, each element of the embodiments, each element of the drawings, etc.) are possible. That is, the present disclosure as a matter of course encompasses the entire disclosure, including the claims, and various modifications and alterations that would be obvious to one skilled in the art based on the technical concept.

What is claimed is:

1. A signature system, comprising
a plurality of first apparatuses, each configured to generate a distributed signature,
wherein at least one first apparatus of the plurality of first apparatuses including at least a processor configured to:
receive a first parameter generated using a distributed signing key corresponding to the at least one first apparatus and first biometric information; and
generate the distributed signature using second biometric information and the first parameter.

2. The signature system according to claim 1 further comprising
a second apparatus including at least a processor configured to generate a plurality of distributed signing keys, each corresponding to each of the plurality of first apparatuses;
a third apparatus including at least a processor configured to generate the first parameter using the distributed signing key corresponding to the at least one of the first apparatus the and first biometric information; and
a fourth apparatus including at least a processor configured to perform verification of a single signature into which the plurality of the distributed signatures are aggregated.

3. The signature system according to claim 2, comprising
a fifth apparatus including at least a processor configured to:
receive the plurality of distributed signatures each generated by the plurality of first apparatuses using the plurality of distributed signing keys for a message to be signed; and
generate the single signature into which the plurality of the distributed signatures are aggregated.

4. The signature system according to claim 1, wherein a k-th (k=2, . . . , n−1) first apparatus among n number (where n is an integer greater than or equal to 2) of the first apparatuses including at least a processor configured to:
receive a (k−1)th distributed signature generated by a (k−1)th first apparatus,
generate a k-th distributed signature, based on the k-th distributed signing key and the (k−1)th distributed signature, or based on the second biometric information and the first parameter generated based on the k-th distributed signing key and the (k−1)th distributed signature; and
transmit the k-th distributed signature to a (k+1)th first apparatus,
wherein the n-th first apparatus includes at least a processor configured to output n-th distributed signature as a single signature into which n number of the distributed signatures are aggregated.

5. The signature system according to claim 1, wherein the at least a processor included in the at least one first apparatus is configured to
with the distributed signing key as a share of the signing key,
receive the first parameter generated using the distributed signing key and the first biometric information, and
generate a distributed signature using the second biometric information and the first parameter.

6. The signature system according to claim 1, wherein the plurality of first apparatuses are configured to generate the distributed signatures according to a predetermined signature scheme selected from an aggregate signature scheme, a sequential aggregate signature scheme, a multi-signature scheme, and a threshold signature scheme.

7. The signature system according to claim 1, wherein the at least one first apparatus includes a first processing unit and a second processing unit to communicate with each other, wherein
the first processing unit is configured to receive the first parameter, and
the second processing unit is configured to acquire the second biometric information.

8. The signature system according to claim 7, wherein, in the at least one first apparatus,
the second processing unit is configured to:
generate a differential key;
generate a second parameter using the first biometric information and the differential key; and
transmit the second parameter to the first processing unit; and
the first processing unit is configured to:
generate a temporary distributed signing key using the first parameter and the second parameter;
generate a temporary distributed signature for a message to be signed using the temporary distributed signing key; and
transmit the temporary distributed signature to the second processing unit; and
the second processing unit is further configured to generate the distributed signature corresponding to the at least one first apparatus using the temporary distributed signature received from the first processing unit and the differential key.

9. A signature method in which each of a plurality of distributed signature generation parts generates a distributed signature, the method comprising,
by at least one distributed signature generation part of the plurality of distributed signature generation parts:
receiving a first parameter generated using a distributed signing key corresponding to the at least one distributed signature generation part and first biometric information; and
generating the distributed signature using second biometric information and the first parameter.

10. The signature method according to claim 9, comprising
generating by a key generation part, a plurality of the distributed signing keys,
generating, by a parameter generation part, the first parameter from a pair of the distributed signing key corresponding to the at least one distributed signature generation part and the first biometric information; and
performing by a signature verification part, verification on a single signature into which the plurality of distributed signatures are aggregated.

11. The signature method according to claim 9, comprising
receiving, by a signature aggregation part, the plurality of distributed signatures generated using the plurality of distributed signing keys; and
generating, by the signature aggregation part, a single aggregate signature.

12. The signature method according to claim 9, comprising
by k-th (k=2, . . . , n−1) distributed signature generation part among n number (where n is an integer greater than or equal to 2) of the distributed signature generation parts:
receiving a (k−1)th distributed signature generated by a (k−1)th distributed signature generation part;
generating a k-th distributed signature by updating the (k−1)th distributed signature using a distributed signature generated with k-th distributed signing key; and
transmitting the k-th distributed signature to (k+1)th distributed signature generation part, the method comprising
outputting, by a n-th distributed signature generation part, n-th distributed signature generated as an single aggregated signature.

13. The signature method according to claim 9, comprising
by the plurality of distributed signature generation parts, generating the distributed signature according to one of a predetermined signature scheme selected from an aggregate signature scheme, a sequential aggregate signature scheme, a multi-signature scheme, and a threshold signature scheme.

14. The signature method according to claim 9, comprising
by the at least one distributed signature generation part, with the distributed signing key as a share of the signing key:
receiving the first parameter generated using the distributed signing key and the first biometric information; and
generating a distributed signature using the second biometric information and the first parameter.

15. The signature method according to claim 9, comprising
receiving the first parameter, by a first unit included in the at least one distributed signature generation part; and
acquiring the second biometric information, by a second unit included in the at least one distributed signature generation part.

16. The signature method according to claim 15, comprising
by the second unit:
generating a differential key;
generating a second parameter using the first biometric information and the differential key; and
transmitting the second parameter to the first unit, the method comprising, by the first unit:
generating a temporary distributed signing key using the first parameter and the second parameter, generates a temporary distributed signature for a message to be signed using the temporary distributed signing key; and
transmitting the temporary distributed signature to the second unit, the method comprising,
by the second unit, generating the distributed signature using the temporary distributed signature received from the first unit and the differential key.

17. A non-transitory computer readable medium storing a program to cause a processor of at least one distributed signature generation apparatus of a plurality of distributed signature generation apparatuses, each generating a distributed signature, to execute processing comprising
receiving a first parameter generated from a distributed signing key corresponding to the at least one distributed signature generation apparatus and first biometric information; and
generating the distributed signature using second biometric information and the first parameter.
